(19) United States
(12) Patent Application Publication
(10) Pub. No.: US 2026/0020087 A1
(43) Pub. Date: Jan. 15, 2026

(54) SYSTEMS, APPARATUSES, METHODS, AND COMPUTER PROGRAM PRODUCTS FOR INITIATING PERFORMANCE OF ONE OR MORE AVIATION OPERATION ACTIONS

(71) Applicant: Honeywell International Inc., Charlotte, NC (US)

(72) Inventors: Muthusankar Subramaniyan, Madurai (IN); Sivakumar Kanagarajan, Bangalore (IN); Gobinathan Baladhandapani, Madurai (IN)

(21) Appl. No.: 18/931,450

(22) Filed: Oct. 30, 2024

(30) Foreign Application Priority Data
Jul. 10, 2024 (IN) 202411052770

(51) Int. Cl. H04W 76/14; H04W 8/22; H04W 84/06

(52) U.S. Cl. CPC H04W 76/14; H04W 8/22; H04W 84/06

(57) ABSTRACT

Systems, apparatuses, methods, and computer program products are provided herein. For example, a method may include determining that a first communication channel between a first aircraft and an aviation operations control system is unavailable. In some embodiments, the method includes detecting one or more other aircraft using at least one detection operation. In some embodiments, the method includes identifying aircraft operations data associated with the one or more other aircraft. In some embodiments, the method includes determining a relay aircraft from the one or more other aircraft by applying the aircraft operations data to a relay aircraft model. In some embodiments, the method includes causing a second communication channel to be established between the first aircraft and the relay aircraft. In some embodiments, the method includes initiating performance of one or more aviation operation actions using the second communication channel.

### CROSS REFERENCE TO RELATED APPLICATIONS

This application claims the benefit of India Provisional Patent Application No. 202411052770, filed Jul. 10, 2024, the entire contents of which are incorporated by reference herein.

### TECHNOLOGICAL FIELD

Embodiments of the present disclosure relate generally to systems, apparatuses, methods, and computer program products for initiating performance of one or more aviation operation actions.

### BACKGROUND

Applicant has identified many technical challenges and difficulties associated with systems, apparatuses, methods, and computer program products initiating performance of one or more aviation operation actions. Through applied effort, ingenuity, and innovation, Applicant has solved problems related to systems, apparatuses, methods, and computer program products for initiating performance of one or more aviation operation actions by developing solutions embodied in the present disclosure, which are described in detail below.

### BRIEF SUMMARY

Various embodiments described herein relate to systems, apparatuses, methods, and computer program products for initiating performance of one or more aviation operation actions.

In accordance with another aspect of the disclosure, a method is provided. In some embodiments, the method includes determining that a first communication channel between a first aircraft and an aviation operations control system is unavailable. In some embodiments, the method includes detecting one or more other aircraft using at least one detection operation. In some embodiments, the one or more other aircraft are in proximity to the first aircraft. In some embodiments, the method includes identifying aircraft operations data associated with the one or more other aircraft. In some embodiments, the method includes determining a relay aircraft from the one or more other aircraft by applying the aircraft operations data to a relay aircraft model. In some embodiments, the aircraft operations data is indicative of one or more aviation-related features associated with the one or more other aircraft. In some embodiments, the method includes causing a second communication channel to be established between the first aircraft and the relay aircraft. In some embodiments, the method includes initiating performance of one or more aviation operation actions using the second communication channel.

In some embodiments, the aviation operations control system comprises a very high frequency omnidirectional range station.

In some embodiments, the aviation operations control system comprises a global positioning system (GPS) satellite.

In some embodiments, the aviation operations control system comprises an air traffic control system.

In some embodiments, the at least one detection operation comprises detecting transponder data associated with one or more transponders.

In some embodiments, the one or more transponders comprise a Mode-A transponder, a Mode-B transponder, a Mode-C transponder, or an ADS-B transponder.

In some embodiments, a first transponder of the one or more transponders is physically located on a first other aircraft of the one or more other aircraft.

In some embodiments, the at least one detection operation comprises detecting aircraft audio data.

In some embodiments, the method further includes generating an other aircraft interface component.

In some embodiments, the other aircraft interface component comprises one or more aircraft items.

In some embodiments, each of the one or more aircraft items is associated with one of the one or more other aircraft.

In some embodiments, the method further includes causing the other aircraft interface component to be rendered to an aviation operations interface.

In some embodiments, the method further includes generating a relay aircraft interface component.

In some embodiments, the relay aircraft interface component comprises one or more aircraft action items.

In some embodiments, the method further includes causing the relay aircraft interface component to be rendered to the aviation operations interface in response to a selection of at least one of the one or more aircraft items.

In some embodiments, initiating performance of the one or more aviation operation actions includes causing aircraft position data associated with the first aircraft to be provided to the aviation operations control system using the second communication channel.

In some embodiments, initiating performance of the one or more aviation operation actions includes providing a message to the relay aircraft using the second communication channel.

In some embodiments, initiating performance of the one or more aviation operation actions includes receiving an aviation operation command via the second communication channel.

In some embodiments, initiating performance of the one or more aviation operation actions includes causing actuation of one or more onboard components of the first aircraft based on the aviation operation command.

In some embodiments, the method further includes establishing one or more additional communication channels with one or more other relay aircraft.

In some embodiments, the relay aircraft is associated with a digital relay capability.

In accordance with another aspect of the disclosure, an apparatus is provided. In some embodiments, the apparatus includes memory and one or more processors communicatively coupled to the memory. In some embodiments, the one or more processors are configured to determine that a first communication channel between a first aircraft and an aviation operations control system is unavailable. In some embodiments, the one or more processors are configured to detect one or more other aircraft using at least one detection operation. In some embodiments, the one or more other aircraft are in proximity to the first aircraft. In some embodiments, the one or more processors are configured to identify aircraft operations data associated with the one or more other aircraft. In some embodiments, the one or more processors are configured to determine a relay aircraft from the one or more other aircraft by applying the aircraft operations data to a relay aircraft model. In some embodiments, the aircraft operations data is indicative of one or more aviation-related features associated with the one or more other aircraft. In some embodiments, the one or more processors are configured to cause a second communication channel to be established between the first aircraft and the relay aircraft. In some embodiments, the one or more processors are configured to initiate performance of one or more aviation operation actions using the second communication channel.

In some embodiments, the aviation operations control system comprises a very high frequency omnidirectional range station, a global positioning system (GPS) satellite, or an air traffic control system.

In some embodiments, the one or more processors are further configured to establish one or more additional communication channels with one or more other relay aircraft.

In some embodiments, the at least one detection operation comprises detecting transponder data associated with one or more transponders or detecting aircraft audio data.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for determining that a first communication channel between a first aircraft and an aviation operations control system is unavailable. In some embodiments, the computer program code, in execution with at least one processor, configures the computer program product for detecting one or more other aircraft using at least one detection operation. In some embodiments, the one or more other aircraft are in proximity to the first aircraft. In some embodiments, the computer program code, in execution with at least one processor, configures the computer program product for identifying aircraft operations data associated with the one or more other aircraft. In some embodiments, the computer program code, in execution with at least one processor, configures the computer program product for determining a relay aircraft from the one or more other aircraft by applying the aircraft operations data to a relay aircraft model. In some embodiments, the aircraft operations data is indicative of one or more aviation-related features associated with the one or more other aircraft. In some embodiments, the computer program code, in execution with at least one processor, configures the computer program product for causing a second communication channel to be established between the first aircraft and the relay aircraft. In some embodiments, the computer program code, in execution with at least one processor, configures the computer program product for initiating performance of one or more aviation operation actions using the second communication channel.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of an example apparatus that may be specially configured in accordance with an example embodiment of the present disclosure;

FIG. 3 illustrates an example block diagram of a first aircraft in accordance with one or more embodiments of the present disclosure;

FIG. 4 illustrates an interface component in accordance with one or more embodiments of the present disclosure;

FIG. 5 illustrates an interface component in accordance with one or more embodiments of the present disclosure;

FIG. 6 illustrates an interface in accordance with one or more embodiments of the present disclosure;

FIG. 7 illustrates a flowchart of an example method in accordance with one or more embodiments of the present disclosure;

FIG. 8 illustrates a flowchart of an example method in accordance with one or more embodiments of the present disclosure;

FIG. 9 illustrates a flowchart of an example method in accordance with one or more embodiments of the present disclosure; and

FIG. 10 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with initiating performance of one or more aviation operation actions. As would be understood by one skilled in the field to which this disclosure pertains, there are numerous example scenarios in which it may be desirable to initiate performance of one or more aviation operation actions.

In many applications, systems, apparatuses, methods, and computer program products for initiating performance of one or more aviation operation actions are desirable. In some implementations, it may be desirable to initiate performance of one or more aviation operation actions using a mobile aviation operations apparatus, an onboard aviation operations apparatus, and/or a cloud-based aviation operations apparatus. In some implementations, it may be desirable to initiate performance of one or more aviation operation actions using a communication channel between an aircraft and a relay aircraft. For example, it may be desirable to initiate performance of one or more aviation operation actions using a communication channel between an aircraft and a relay aircraft when a communication channel between an aircraft and an aviation operations control system is unavailable.

Example solutions for initiating performance of one or more aviation operation actions include using an onboard component of an aircraft to communicate with an aviation operations control system (e.g., a GPS satellite). In some examples, such example solutions are able to initiate performance of one or more aviation operation actions based on communications between an onboard component of an aircraft and an aviation operations control system. However, such example solutions are unreliable, fail to meet safety standards, inefficient, and cumbersome. For example, such example solutions are unreliable because communication between an onboard component of an aircraft and an aviation operations control system may periodically become unavailable due to one or more obstacles (e.g., weather, topographical features, etc.). As another example, such example solutions fail to meet safety standards because if communication between an onboard component of an aircraft and an aviation operation control system is periodically unavailable, the onboard component may not be able to initiate performance of one or more aviation operation actions that are required for the safe operation of the aircraft. As another example, such example solutions are inefficient because if communication between an onboard component of an aircraft and an aviation operation control system is periodically unavailable, the onboard component may not be able to initiate performance of one or more aviation operation actions in an efficient and orderly manner. As another example, such example solutions are cumbersome because such example solutions do not enable dynamically initiating performance of one or more aviation operation actions by using one or more of a mobile aviation operations apparatus, an onboard aviation operations apparatus, and/or a cloud-based aviation operations apparatus. Accordingly, there is a need for systems, apparatuses, methods, and computer program products that are capable of initiating performance of one or more aviation operation actions in a reliable, safe, efficient, and dynamic manner.

Thus, to address these and/or other issues related to such example solutions, example systems, apparatuses, methods, and computer program products for initiating performance of one or more aviation operation actions are disclosed herein. For example, an embodiment in this disclosure, described in greater detail below, includes a method that includes determining that a first communication channel between a first aircraft and an aviation operations control system is unavailable. In some embodiments, the method includes detecting one or more other aircraft using at least one detection operation. In some embodiments, the one or more other aircraft are in proximity to the first aircraft. In some embodiments, the method includes identifying aircraft operations data associated with the one or more other aircraft. In some embodiments, the method includes determining a relay aircraft from the one or more other aircraft by applying the aircraft operations data to a relay aircraft model. In some embodiments, the aircraft operations data is indicative of one or more aviation-related features associated with the one or more other aircraft. In some embodiments, the method includes causing a second communication channel to be established between the first aircraft and the relay aircraft. In some embodiments, the method includes initiating performance of one or more aviation operation actions using the second communication channel. Accordingly, the systems, apparatuses, methods, and computer program products disclosed herein enable for initiating performance of one or more aviation operation actions in a reliable, safe, efficient, and dynamic manner.

### Example Systems and Apparatuses

Embodiments of the present disclosure herein include systems, apparatuses, methods, and computer program products configured for initiating performance of one or more aviation operation actions. It should be readily appreciated that the embodiments of the apparatus, systems, methods, and computer program product described herein may be configured in various additional and alternative manners in addition to those expressly described herein.

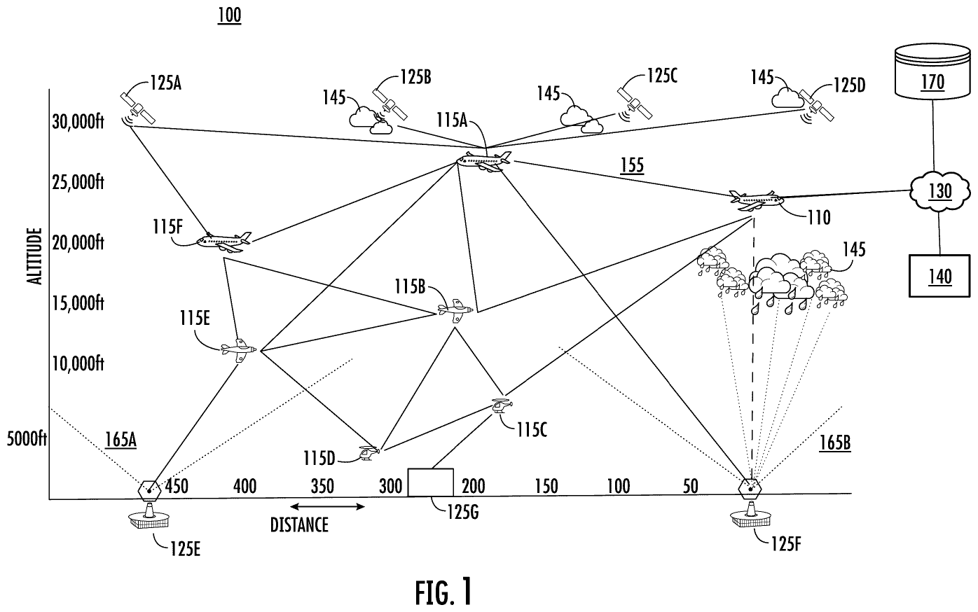

FIG. 1 illustrates an example diagram of an environment 100 in which embodiments of the present disclosure may operate. Specifically, FIG. 1 illustrates a first aircraft 110. In some embodiments, the first aircraft 110 may describe any machine, robot, computing device, and/or apparatus comprised of hardware, software, firmware, and/or any combination thereof, that maneuvers throughout an environment through a medium, such as air. In some contexts, the first aircraft 110 is utilized to transport objects, entities (e.g., people, animals, or other beings), and/or other onboard cargo. In some situations, the first aircraft 110 may be transporting no object except for the aircraft itself. Examples of the first aircraft 110 include airplanes, helicopters, drones, and/or the like. In some embodiments, the first aircraft 110 is not limited to the examples listed herein and may include other types of transportation device.

In some embodiments, the environment 100 illustrated in FIG. 1 includes a one or more other aircraft 115. For example, such as illustrated in FIG. 1, the one or more other aircraft 115 may include a first other aircraft 115A, a second other aircraft 115B, a third other aircraft 115C, a fourth other aircraft 115D, a fifth other aircraft 115E, a sixth other aircraft 115F, and/or the like. Although six other aircraft are depicted in the one or more other aircraft 115 in FIG. 1, it would be understood by one skilled in the field to which this disclosure pertains that there may be more or less other aircraft in the environment 100.

In some embodiments, the one or more other aircraft 115 may each describe any machine, robot, computing device, and/or apparatus comprised of hardware, software, firmware, and/or any combination thereof, that maneuvers throughout an environment through a medium, such as air. In some contexts, the one or more other aircraft 115 are each utilized to transport objects, entities (e.g., people, animals, or other beings), and/or other onboard cargo. In some situations, the one or more other aircraft 115 may be transporting no object except for the aircraft itself. Examples of the one or more other aircraft 115 include airplanes, helicopters, drones, and/or the like. In some embodiments, the one or more other aircraft 115 is not limited to the examples listed herein and may include other types of transportation device. Said differently, for example, the one or more other aircraft 115 may include any other aircraft in the environment 100 besides the first aircraft 110.

In some embodiments, the first aircraft 110 and/or the one or more other aircraft 115 are associated with a determinable location. A determinable location of the first aircraft 110 and/or the one or more other aircraft 115 in some embodiments represents an absolute position (e.g., GPS coordinates, latitude and longitude locations, an address, and/or the like) or a relative position of the first aircraft 110 and/or the one or more other aircraft 115 (e.g., an identifier representing the location of the first aircraft 110 and/or the one or more other aircraft 115 as compared to one or more other aircraft (e.g., the first aircraft 110 as compared to the first other aircraft 115A), one or more buildings (e.g., an airport), an enterprise headquarters, or general description in the world for example based at least in part on continent, state, ocean, or other definable region). In some embodiments, the first aircraft 110 and/or the one or more other aircraft 115 include or otherwise are associated with a location sensor and/or software-driven location services that provide the location data corresponding to the first aircraft 110 and/or the one or more other aircraft 115. In other embodiments, the location of the first aircraft 110 and/or the one or more other aircraft 115 is stored and/or otherwise determinable to one or more systems.

In some embodiments, the environment 100 illustrated in FIG. 1 includes one or more aviation operations control systems 125. In some embodiments, the one or more aviation operations control systems 125 are configured to facilitate navigation and/or communication for the first aircraft 110 and/or the one or more other aircraft 115 in the environment 100. In this regard, for example, the one or more aviation operations control systems 125 may be configured to at least partially control the first aircraft 110 and/or the one or more other aircraft 115 in a designated control space.

In some embodiments, the one or more aviation operations control systems 125 includes one or more air traffic control systems. For example, the one or more aviation operations control systems 125 may include a first air traffic control system 125G. For example, the first air traffic control system 125G may be an aircraft control tower associated with an airport. Although the environment 100 illustrated in FIG. 1 includes one air traffic control system, it would be understood by one skilled in the field to which this disclosure pertains that the environment 100 may include more air traffic control systems (e.g., two air traffic control systems).

In some embodiments, the one or more aviation operations control systems 125 includes one or more global positioning system (GPS) satellites. For example, the one or more aviation operations control systems 125 may include a first GPS satellite 125A, a second GPS satellite 125B, a third GPS satellite 125C, and/or a fourth GPS satellite 125D. Although the environment 100 illustrated in FIG. 1 includes four GPS satellites, it would be understood by one skilled in the field to which this disclosure pertains that the environment 100 may include more or fewer GPS satellites (e.g., five or three GPS satellites).

In some embodiments, the one or more aviation operations control systems 125 includes one or more very high frequency omnidirectional range stations. For example, the one or more aviation operations control systems 125 may include a first very high frequency omnidirectional range station 125E and/or a second very high frequency omnidirectional range station 125F. Although the environment 100 illustrated in FIG. 1 includes two high frequency omnidirectional range stations, it would be understood by one skilled in the field to which this disclosure pertains that the environment 100 may include more or fewer very high frequency omnidirectional range stations (e.g., one or three very high frequency omnidirectional range stations).

In some embodiments, the first very high frequency omnidirectional range station 125E is associated with a first range 165A. In some embodiments, the first range 165A defines an area and/or direction in which the first very high frequency omnidirectional range station 125E can facilitate navigation and/or communication for the first aircraft 110 and/or the one or more other aircraft 115. For example, based on the first range 165A, the first very high frequency omnidirectional range station 125E may be unable to facilitate navigation and/or communication for the fourth other aircraft 115D because the fourth other aircraft 115D is outside of the first range 165A.

In some embodiments, the second very high frequency omnidirectional range station 125F is associated with a second range 165B. In some embodiments, the second range 165B defines an area and/or direction in which the second very high frequency omnidirectional range station 125F may facilitate navigation and/or communication for the first aircraft 110 and/or the one or more other aircraft 115. For example, based on the second range 165B, the second very high frequency omnidirectional range station 125F may be unable to facilitate navigation and/or communication for the third other aircraft 115C because the third other aircraft 115C is outside of the second range 165B.

In some embodiments, the first aircraft 110, the one or more other aircraft 115, and/or the one or more aviation operations control systems 125 may communicate via one or more communication channels 155. In some embodiments, each of the one or more communication channels 155 is an electronic communication medium through which data, signals, and/or the like may be transmitted. For example, each of the one or more communication channels 155 may be an electronic communication medium through which data, signals, and/or the like may be transmitted between the first aircraft 110, the one or more other aircraft 115, and/or the one or more aviation operations control systems 125.

In some embodiments, the environment 100 includes one or more obstacles 145. For example, the one or more obstacles 145 may include topographical aviation-related features (e.g., mountains, hills, bodies of water, the curvature of the earth, etc.), structures (e.g., buildings), and/or weather (e.g., clouds, thunderstorms, etc.). In some embodiments, the one or more obstacles may periodically and/or permanently block one or more of the one or more communication channels 155. In this regard, for example, the one or more obstacles may cause one or more of the one or more communication channels 155 to periodically and/or permanently become unavailable (e.g., a communication channel may be unavailable when it is blocked by an obstacle).

In some embodiments, the environment 100 includes a cloud-based aviation operations apparatus 140. In some embodiments, the cloud-based aviation operations apparatus 140 is electronically and/or communicatively coupled to the first aircraft 110, the one or more other aircraft 115, the one or more aviation operations control systems 125, a mobile aviation operations apparatus 120, an onboard aviation operations apparatus 180, and/or one or more onboard components 190. The cloud-based aviation operations apparatus 140 may be located remotely from the first aircraft 110. In this regard, for example, the cloud-based aviation operations apparatus 140 may be located in a remote cloud server and electronically and/or communicatively coupled to the first aircraft 110, the one or more other aircraft 115, the one or more aviation operations control systems 125, the mobile aviation operations apparatus 120, the onboard aviation operations apparatus 180, and/or the one or more onboard components 190 via at least the network 130. In some embodiments, the cloud-based aviation operations apparatus 140 is configured via hardware, software, firmware, and/or a combination thereof, to perform data intake of one or more types of data, such as aircraft operations data, updated aircraft operations data, transponder data, aircraft audio data, aircraft position data, and/or the like.

Additionally, or alternatively, in some embodiments, the cloud-based aviation operations apparatus 140 is configured via hardware, software, firmware, and/or a combination thereof, to generate and/or transmit command(s) that control, adjust, or otherwise impact operations of one or more of the first aircraft 110, the one or more other aircraft 115, the one or more aviation operations control systems 125, the mobile aviation operations apparatus 120, the onboard aviation operations apparatus 180, and/or the one or more onboard components 190. For example, the cloud-based aviation operations apparatus 140 may be configured to initiate performance of one or more aviation operation actions. Additionally, or alternatively, in some embodiments, the cloud-based aviation operations apparatus 140 is configured via hardware, software, firmware, and/or a combination thereof, to perform data reporting, provide data, and/or other data output process(es) associated with monitoring or otherwise analyzing operations of one or more of the first aircraft 110, the one or more other aircraft 115, the one or more aviation operations control systems 125, the mobile aviation operations apparatus 120, the onboard aviation operations apparatus 180, and/or the one or more onboard components 190. For example, in various embodiments, the cloud-based aviation operations apparatus 140 may be configured to execute and/or perform one or more operations and/or functions described herein.

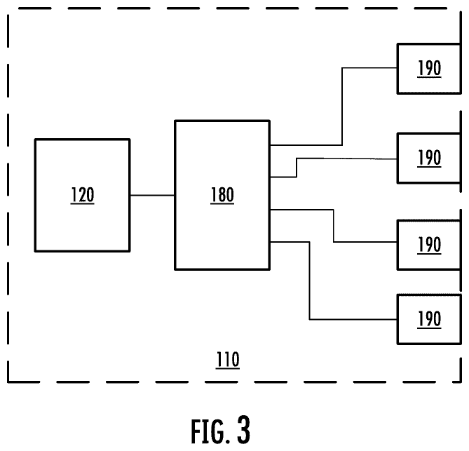

In some embodiments, such as illustrated in FIG. 3, the first aircraft 110 includes the mobile aviation operations apparatus 120. In some embodiments, the mobile aviation operations apparatus 120 is electronically and/or communicatively coupled to the first aircraft 110, the one or more other aircraft 115, the one or more aviation operations control systems 125, the cloud-based aviation operations apparatus 140, the onboard aviation operations apparatus 180, and/or the one or more onboard components 190. The mobile aviation operations apparatus 120 may be located remotely from the first aircraft 110, in proximity of the first aircraft 110 (e.g., with a pilot at an airport gate associated with the first aircraft 110), and/or within the first aircraft 110 (e.g., with the pilot in the first aircraft 110). In this regard, for example, the mobile aviation operations apparatus 120 may be portable. In some embodiments, the mobile aviation operations apparatus 120 is an electronic flight bag. In some embodiments, the mobile aviation operations apparatus 120 is configured via hardware, software, firmware, and/or a combination thereof, to perform data intake of one or more types of data, such as aircraft operations data, updated aircraft operations data, transponder data, aircraft audio data, aircraft position data, and/or the like.

Additionally, or alternatively, in some embodiments, the mobile aviation operations apparatus 120 is configured via hardware, software, firmware, and/or a combination thereof, to generate and/or transmit command(s) that control, adjust, or otherwise impact operations of one or more of the first aircraft 110, the one or more other aircraft 115, the one or more aviation operations control systems 125, the cloud-based aviation operations apparatus 140, the onboard aviation operations apparatus 180, and/or the one or more onboard components 190. For example, the mobile aviation operations apparatus 120 may be configured to initiate performance of one or more aviation operation actions. Additionally, or alternatively, in some embodiments, the mobile aviation operations apparatus 120 is configured via hardware, software, firmware, and/or a combination thereof, to perform data reporting, provide data, and/or other data output process(es) associated with monitoring or otherwise analyzing operations of one or more of the first aircraft 110, the one or more other aircraft 115, the one or more aviation operations control systems 125, the cloud-based aviation operations apparatus 140, the onboard aviation operations apparatus 180, and/or the one or more onboard components 190. For example, in various embodiments, the mobile aviation operations apparatus 120 may be configured to execute and/or perform one or more operations and/or functions described herein.

In some embodiments, such as illustrated in FIG. 3, the first aircraft 110 includes the onboard aviation operations apparatus 180. In some embodiments, the onboard aviation operations apparatus 180 is electronically and/or communicatively coupled to the first aircraft 110, the one or more other aircraft 115, the one or more aviation operations control systems 125, the cloud-based aviation operations apparatus 140, the mobile aviation operations apparatus 120, and/or the one or more onboard components 190. The onboard aviation operations apparatus 180 may be located within the first aircraft 110 (e.g., as a component of the first aircraft 110). In this regard, for example, the onboard aviation operations apparatus 180 may physically secured to the first aircraft 110. In some embodiments, the onboard aviation operations apparatus 180 is configured via hardware, software, firmware, and/or a combination thereof, to perform data intake of one or more types of data, such as aircraft operations data, updated aircraft operations data, transponder data, aircraft audio data, aircraft position data, and/or the like.

Additionally, or alternatively, in some embodiments, the onboard aviation operations apparatus 180 is configured via hardware, software, firmware, and/or a combination thereof, to generate and/or transmit command(s) that control, adjust, or otherwise impact operations of one or more of the first aircraft 110, the one or more other aircraft 115, the one or more aviation operations control systems 125, the cloud-based aviation operations apparatus 140, the mobile aviation operations apparatus 120, and/or the one or more onboard components 190. For example, the onboard aviation operations apparatus 180 may be configured to initiate performance of one or more aviation operation actions. Additionally, or alternatively, in some embodiments, the onboard aviation operations apparatus 180 is configured via hardware, software, firmware, and/or a combination thereof, to perform data reporting, provide data, and/or other data output process(es) associated with monitoring or otherwise analyzing operations of one or more of the first aircraft 110, the one or more other aircraft 115, the one or more aviation operations control systems 125, the cloud-based aviation operations apparatus 140, the mobile aviation operations apparatus 120, and/or the one or more onboard components 190. For example, in various embodiments, the onboard aviation operations apparatus 180 may be configured to execute and/or perform one or more operations and/or functions described herein.

In some embodiments, the environment 100 may include an aviation operations apparatus. In some embodiments, the aviation operations apparatus may be at least partially embodied as the mobile aviation operations apparatus 120. Additionally, or alternatively, the aviation operations apparatus may be at least partially embodied as the onboard aviation operations apparatus 180. Additionally, or alternatively, the aviation operations apparatus may be at least partially embodied as the cloud-based aviation operations apparatus 140.

In some embodiments, such as illustrated in FIG. 3, the first aircraft 110 includes the one or more onboard components 190. In some embodiments, the one or more onboard components 190 are electronically and/or communicatively coupled to the first aircraft 110, the one or more other aircraft 115, the one or more aviation operations control systems 125, the cloud-based aviation operations apparatus 140, the mobile aviation operations apparatus 120, and/or the onboard aviation operations apparatus 180. The one or more onboard components 190 may be located within the first aircraft 110. In this regard, for example may be one or more individual components of the first aircraft 110 that perform a particular function during operation of the first aircraft 110. For example, the one or more onboard components 190 may include one or more of multi-function control and display units (MCDU), flight management systems (FMS), inertial reference systems (IRS), sensors, actuators, primary flight displays, radars (e.g., weather radars, engines, auxiliary power units (APU), enhanced ground proximity warning systems (EGPWS), transponders (e.g., Mode-A transponders, Mode-B transponders, Mode-C transponders, or ADS-B transponders), radio components (e.g., for communicating with the one or more other aircraft 115), and/or the like. In this regard, for example, the individual components of the first aircraft 110 may include components associated with a particular process or operation performed by the first aircraft 110. In some embodiments, the one or more onboard components 190 are physically secured to the first aircraft 110.

In some embodiments, the one or more onboard components 190 are configured via hardware, software, firmware, and/or a combination thereof, to perform data intake of one or more types of data, such as such as aircraft operations data, updated aircraft operations data, transponder data, aircraft audio data, aircraft position data, and/or the like. Additionally, or alternatively, in some embodiments, the one or more onboard components 190 are configured via hardware, software, firmware, and/or a combination thereof, to generate and/or transmit command(s) that control, adjust, or otherwise impact operations of one or more of the first aircraft 110, the one or more other aircraft 115, the one or more aviation operations control systems 125, the cloud-based aviation operations apparatus 140, the mobile aviation operations apparatus 120, and/or the onboard aviation operations apparatus 180. For example, the one or more onboard components 190 may be configured to initiate performance of one or more aviation operation actions. Additionally, or alternatively, in some embodiments, the one or more onboard components 190 are configured via hardware, software, firmware, and/or a combination thereof, to perform data reporting, provide data, and/or other data output process(es) associated with monitoring or otherwise analyzing operations of one or more of the first aircraft 110, the one or more other aircraft 115, the one or more aviation operations control systems 125, the cloud-based aviation operations apparatus 140, the mobile aviation operations apparatus 120, and/or the onboard aviation operations apparatus 180. For example, in various embodiments, the one or more onboard components 190 may be configured to execute and/or perform one or more operations and/or functions described herein.

The one or more databases 170 may be configured to receive, store, and/or transmit data. For example, the one or more databases 170 may be configured to receive, store, and/or transmit data associated with the first aircraft 110, the one or more other aircraft 115, the one or more aviation operations control systems 125, the cloud-based aviation operations apparatus 140, the mobile aviation operations apparatus 120, the one or more onboard components 190, and/or the onboard aviation operations apparatus 180. In this regard, for example, the one or more databases 170 may be configured to receive, store, and/or transmit aircraft operations data, updated aircraft operations data, transponder data, aircraft audio data, aircraft position data, and/or the like. The one or more databases 170 may be located remotely from the first aircraft 110, in proximity of the first aircraft 110, and/or within the first aircraft 110.

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the cloud-based aviation operations apparatus 140 may include the one or more databases 170.

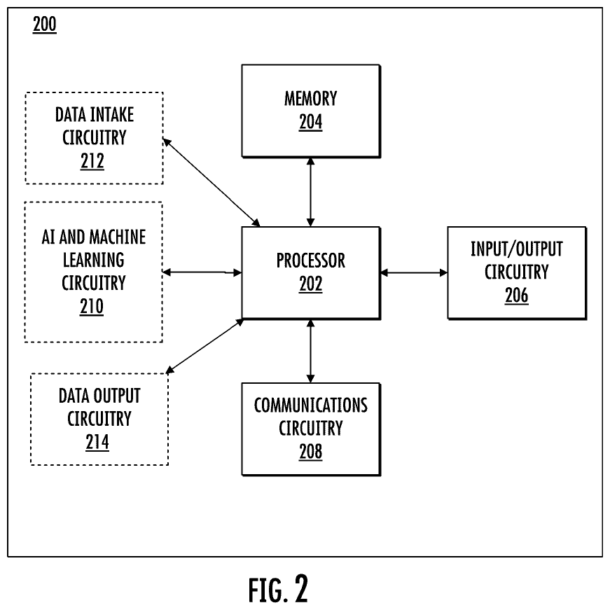

FIG. 2 illustrates an example block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. For example, the computing apparatus 200 may be embodied as one or more of a specifically configured personal computing apparatus, a specifically configured cloud-based computing apparatus, a specifically configured embedded computing device (e.g., configured for edge computing, and/or the like). Examples of an apparatus 200 may include, but is not limited to, the first aircraft 110, the one or more other aircraft 115, the one or more aviation operations control systems 125, the cloud-based aviation operations apparatus 140, the mobile aviation operations apparatus 120, the one or more onboard components 190, and/or the onboard aviation operations apparatus 180. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 200 of the first aircraft 110, the one or more other aircraft 115, the one or more aviation operations control systems 125, the cloud-based aviation operations apparatus 140, the mobile aviation operations apparatus 120, the one or more onboard components 190, and/or the onboard aviation operations apparatus 180 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuitry 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally, or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the first aircraft 110. In some embodiments, the data intake circuitry 212 includes hardware, software, firmware, and/or a combination thereof, that communicates with one or more sensor(s) component(s), and/or the like within the first aircraft 110 to receive particular data associated with such operations of the first aircraft 110. Additionally, or alternatively, in some embodiments, the data intake circuitry 212 includes hardware, software, firmware, and/or a combination thereof, that retrieves particular data associated with the first aircraft 110 from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally, or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect to the AI and machine learning circuitry 210.

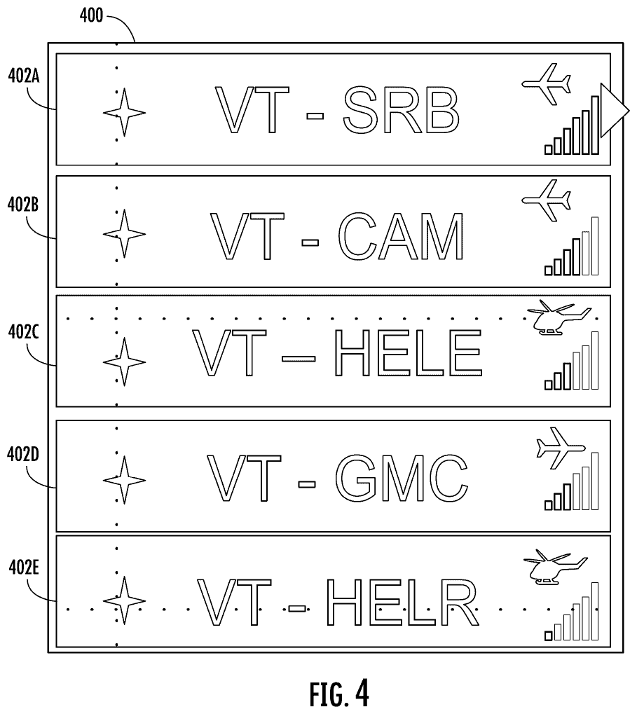

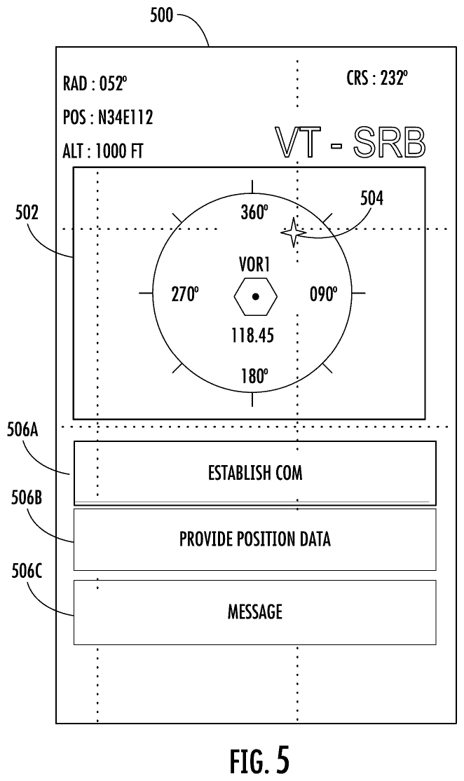

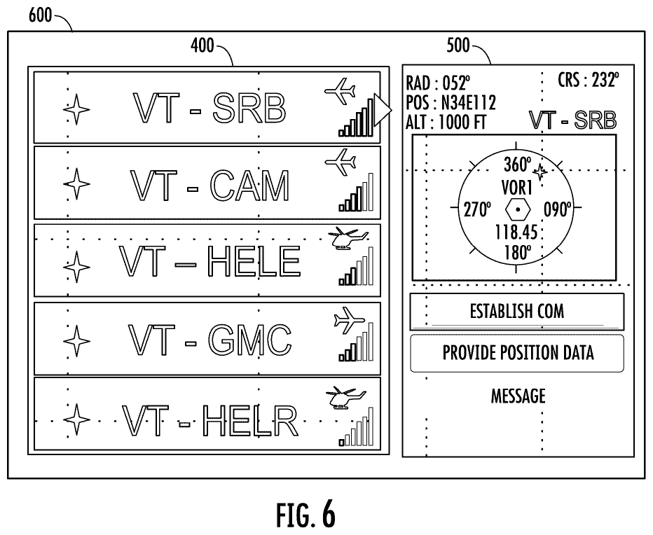

With reference to FIGS. 1-6, in some embodiments, the aviation operations apparatus (e.g., the mobile aviation operations apparatus 120, the onboard aviation operations apparatus 180, and/or the cloud-based aviation operations apparatus 140) is configured to determine that a communication channel between the first aircraft 110 and an aviation operations control system of the one or more aviation operations control systems 125 is unavailable (e.g., a first communication channel of the one or more communication channels 155). For example, such as illustrated in FIG. 1, the aviation operations apparatus may be configured to determine that a communication channel between the first aircraft 110 and the second very high frequency omnidirectional range station 125F is unavailable (e.g., as indicated by the dashed line in FIG. 1 between the first aircraft 110 and the second very high frequency omnidirectional range station 125F). In some embodiments, a communication channel is unavailable due to one or more of the one or more obstacles 145. For example, a communication channel between the first aircraft 110 and the second very high frequency omnidirectional range station 125F may be unavailable due to a thunderstorm between the first aircraft 110 and the second very high frequency omnidirectional range station 125F.

In some embodiments, the aviation operations apparatus (e.g., the mobile aviation operations apparatus 120, the onboard aviation operations apparatus 180, and/or the cloud-based aviation operations apparatus 140) is configured to determine that a communication channel is unavailable when the aviation operations apparatus is unable to receive signals, data, and/or the like from an aviation operations control system. For example, the aviation operations apparatus may be configured to expect to receive signals, data, and/or the like from an aviation operations control system in a particular time period or geographic location and, when the aviation operations apparatus does not receive signals, data, and/or the like from an aviation operations control system in the particular time period or geographic location, determine that the communication channel is unavailable. Additionally, or alternatively, the aviation operations apparatus is configured to determine that a communication channel is unavailable when the aviation operations apparatus transmits signals, data, and/or the like to an aviation operations control system and does not receive a response.

In some embodiments, the aviation operations apparatus (e.g., the mobile aviation operations apparatus 120, the onboard aviation operations apparatus 180, and/or the cloud-based aviation operations apparatus 140) is configured to detect the one or more other aircraft 115. In some embodiments, the one or more other aircraft 115 are in proximity to the first aircraft 110. In this regard, for example, the aviation operations apparatus may be configured to detect the one or more other aircraft 115 when the one or more other aircraft 115 are in proximity to the first aircraft 110. In some embodiments, the one or more other aircraft 115 are in proximity to the first aircraft 110 when the one or more other aircraft 115 are within a predefined distance of the first aircraft 110. For example, the one or more other aircraft 115 are in proximity to the first aircraft 110 when the one or more other aircraft 115 are within ninety miles of the first aircraft 110.

In some embodiments, the aviation operations apparatus (e.g., the mobile aviation operations apparatus 120, the onboard aviation operations apparatus 180, and/or the cloud-based aviation operations apparatus 140) is configured to detect the one or more other aircraft 115 using at least one detection operation. In some embodiments, a detection operation includes detecting transponder data. For example, the aviation operations apparatus may be configured to detect transponder data using one or more of the one or more onboard components 190 of the first aircraft 110. In some embodiments, each of the one or more other aircraft 115 are associated with one or more of the one or more transponders. In this regard, for example, one or more of the one or more transponders may be physically located on one or more of the one or more other aircraft 115. For example, a first transponder of the one or more transponders may be physically located on the first other aircraft 115A of the one or more other aircraft 115.

In some embodiments, transponder data includes one or more items of data indicative and/or representative of a signal and/or information associated with a transponder. In this regard, for example, transponder data may be associated with one or more transponders. In some embodiments, the one or more transponders includes a Mode-A transponder. In some embodiments, a detection operation includes detecting transponder data that was generated and/or provided by a Mode-A transponder. In some embodiments, the one or more transponders includes a Mode-C transponder. In some embodiments, a detection operation includes detecting transponder data that was generated and/or provided by a Mode-C transponder. In some embodiments, the one or more transponders includes a Mode-S transponder. In some embodiments, a detection operation includes detecting transponder data that was generated and/or provided by a Mode-S transponder. In some embodiments, the one or more transponders includes an ADS-B transponder. In some embodiments, a detection operation includes detecting transponder data that was generated and/or provided by an ADS-B transponder.

In some embodiments, a detection operation includes detecting aircraft audio data. For example, the aviation operations apparatus may be configured to detect aircraft audio data using one or more of the one or more onboard components 190 of the first aircraft 110. In some embodiments, aircraft audio data includes one or more items of data indicative and/or representative of audio associated with one or more of the one or more other aircraft 115. In this regard, for example, aircraft audio data may be generated and/or provided by one or more of the one or more other aircraft 115. For example, aircraft audio data may include one or more items of data indicative and/or representative of a pilot speaking into communications equipment associated with one or more of the one or more other aircraft 115 (e.g., a pilot speaking a location into communications equipment associated with one or more of the one or more other aircraft 115).

In some embodiments, the aviation operations apparatus (e.g., the mobile aviation operations apparatus 120, the onboard aviation operations apparatus 180, and/or the cloud-based aviation operations apparatus 140) is configured to identify aircraft operations data. In some embodiments, the aircraft operations data may be associated with the one or more other aircraft 115. In some embodiments, identifying aircraft operations data includes the aviation operations apparatus being configured to receive aircraft operations data from one or more of the one or more other aircraft 115. In some embodiments, the aviation operations apparatus is configured to receive aircraft operations data from one or more of the one or more other aircraft 115 using the one or more onboard components 190. In some embodiments, one or more transponders of the one or more other aircraft 115 are configured to provide aircraft operations data to the first aircraft 110. In some embodiments, identifying aircraft operations data includes the aviation operations apparatus being configured to access aircraft operations data from the one or more databases 170. In some embodiments, the aviation operations apparatus is configured to generate aviation operations data. For example, the aviation operations apparatus may be configured to generate aviation operations data using transponder data and/or audio data.

In some embodiments, aircraft operations data includes one or more items of data indicative and/or representative of one or more aviation-related features associated with the one or more other aircraft 115. In some embodiments, the one or more aviation-related features associated with the one or more other aircraft 115 indicate whether an aircraft in the one or more other aircraft 115 is in a line of sight of the first aircraft 110. In some embodiments, for example, the one or more other aircraft 115 are in a line of sight of the first aircraft 110 when one or more of the one or more obstacles 145 are not blocking a line of sight between the first aircraft 110 and the one or more other aircraft 115. For example, the one or more aviation-related features may indicate that the first other aircraft 115A is in a line of sight of the first aircraft 110.

In some embodiments, the one or more aviation-related features associated with the one or more other aircraft 115 indicate whether an aircraft in the one or more other aircraft 115 is in a line of sight of one or more of the one or more aviation operations control systems 125. In some embodiments, for example, an aircraft in the one or more other aircraft 115 is in a line of sight of an aviation operations control system when the one or more obstacles 145 are not blocking a line of sight between the aircraft and the aviation operations control system. For example, the one or more aviation-related features may indicate that the sixth other aircraft 115F is in a line of sight with the first GPS satellite 125A. As another example, the one or more aviation-related features may indicate that the sixth other aircraft 115F is in a line of sight with the first very high frequency omnidirectional range station 125E. As another example, the one or more aviation-related features may indicate that the sixth other aircraft 115F is in a line of sight with the first GPS satellite 125A, the second GPS satellite 125B, the third GPS satellite 125C, and/or the fourth GPS satellite 125D. As another example, the one or more aviation-related features may indicate that the fifth other aircraft 115E is in a line of sight with the first very high frequency omnidirectional range station 125E. As another example, the one or more aviation-related features may indicate that the second other aircraft 115B is in a line of sight with the first very high frequency omnidirectional range station 125E and/or the second very high frequency omnidirectional range station 125F.

In some embodiments, the one or more aviation-related features associated with the one or more other aircraft 115 indicate an altitude. For example, the one or more aviation-related features may indicate that the first other aircraft 115A is at an altitude of approximately 27,000 feet. As another example, the one or more aviation-related features may indicate that the second other aircraft 115B is at an altitude of approximately 27,000 feet. As another example, the one or more aviation-related features may indicate that the third other aircraft 115C is at an altitude of approximately 6,000 feet. As another example, the one or more aviation-related features may indicate that the fourth other aircraft 115D is at an altitude of approximately 4,000 feet. As another example, the one or more aviation-related features may indicate that the fifth other aircraft 115E is at an altitude of approximately 10,000 feet. As another example, the one or more aviation-related features may indicate that the sixth other aircraft 115F is at an altitude of approximately 20,000 feet.

In some embodiments, the one or more aviation-related features associated with the one or more other aircraft 115 indicate a distance from the first aircraft 110 and/or a distance from another of the one or more other aircraft 115. For example, the one or more aviation-related features may indicate that the first other aircraft 115A is approximately 195 nautical miles from the first aircraft 110. As another example, the one or more aviation-related features may indicate that the sixth other aircraft 115F is approximately 225 nautical miles from the first other aircraft 115A.

In some embodiments, the one or more aviation-related features associated with the one or more other aircraft 115 indicate a flight plan. For example, the one or more aviation-related features may indicate that the first other aircraft 115A is implementing a flight plan that includes landing at a particular airport. As another example, the one or more aviation-related features may indicate that the second other aircraft 115B is implementing a flight plan that includes a planned heading and/or altitude change at a particular point in a flight. As another example, the one or more aviation-related features may indicate that the first other aircraft 115A is implementing a flight plan that includes a particular course (e.g., CRS: 232°). As another example, the one or more aviation-related features may indicate that the first other aircraft 115A is implementing a flight plan that includes a particular radial (e.g., 052°).

In some embodiments, the one or more aviation-related features associated with the one or more other aircraft 115 indicate a frequency the one or more other aircraft 115 are using to communicate with one or more of the one or more aviation operations control systems 125 (e.g., via one or more of the one or more communication channels 155). For example, the one or more aviation-related features may indicate that the first other aircraft 115A is communicating with the second GPS satellite 125B using a frequency of 184.75. In this regard, for example, the first GPS satellite 125A, the second GPS satellite 125B, the third GPS satellite 125C, and/or the fourth GPS satellite 125D may be configured to operate using a frequency of 184.75. As another example, the one or more aviation-related features may indicate that the fifth other aircraft 115E is communicating with the first very high frequency omnidirectional range station 125E using a frequency of 118.45. In this regard, for example, the first very high frequency omnidirectional range station 125E may be configured to operate using a frequency of 118.45. As another example, the one or more aviation-related features may indicate that the first other aircraft 115A is communicating with the second very high frequency omnidirectional range station 125F using a frequency of 119.45. In this regard, for example, the second very high frequency omnidirectional range station 125F may be configured to operate using a frequency of 119.45.

In some embodiments, the one or more aviation-related features associated with the one or more other aircraft 115 indicate a direction that the one or more other aircraft 115 are traveling relative to the first aircraft 110. For example, the one or more aviation-related features may indicate that the first other aircraft 115A is heading in approximately the opposite direction to the first aircraft 110. As another example, the one or more aviation-related features may indicate that the second other aircraft 115B is heading in the approximately the same direction and/or the opposite direction as the first aircraft 110.

In some embodiments, the one or more aviation-related features associated with the one or more other aircraft 115 indicate a signal metric. In some embodiments, a signal metric may be indicative of an aircraft's capability for communicating over the one or more communication channels 155 (e.g., how far can an aircraft communicate over a communication channel). For example, the one or more aviation-related features may indicate that the first other aircraft 115A is associated with a signal metric of 5. As another example, the one or more aviation-related features may indicate that the third other aircraft 115C is associated with a signal metric of 2.

In some embodiments, the one or more aviation-related features associated with the one or more other aircraft 115 indicate an aircraft identification. In some embodiments, an aircraft identification may be a tail number associated with an aircraft. For example, the one or more aviation-related features may indicate that the first other aircraft 115A is associated with an aircraft identification of VT-SRB. In some embodiments, the one or more aviation-related features associated with the one or more other aircraft 115 indicate a position of an aircraft in the one or more other aircraft 115. For example, the one or more aviation-related features may indicate that the first other aircraft 115A is associated with a first position (N34E112). In some embodiments, the one or more aviation-related features associated with the one or more other aircraft 115 indicate an aircraft type. For example, the one or more aviation-related features may indicate that the first other aircraft 115A is an airplane. As another example, the one or more aviation-related features may indicate that the third other aircraft 115C is a helicopter.

In some embodiments, the aviation operations apparatus (e.g., the mobile aviation operations apparatus 120, the onboard aviation operations apparatus 180, and/or the cloud-based aviation operations apparatus 140) is configured to determine a relay aircraft. In some embodiments, the aviation operations apparatus is configured to determine a relay aircraft from the one or more other aircraft 115. In some embodiments, a relay aircraft is an aircraft from the one or more other aircraft 115 through which the first aircraft 110 can communicate with one or more of the one or more aviation operations control systems 125. For example, the first other aircraft 115A may be an aircraft through which the first aircraft 110 can communicate with the second very high frequency omnidirectional range station 125F. Said differently, for example, when a communication channel between the first aircraft 110 and an aviation operations control system is unavailable (e.g., due to the one or more obstacles 145), a relay aircraft may be used by the first aircraft 110 to facilitate communication with one or more of the one or more aviation operations control systems 125. In this regard, for example, at least one communication channel of the one or more communication channels 155 between a relay aircraft and an aviation operations control system may be available (e.g., not blocked by obstacles).

In some embodiments, a relay aircraft is associated with a digital relay capability. In this regard, for example, a relay aircraft that is associated with a digital relay capability is configured to communicate over the one or more communication channels 155 using a transponder, an electronic flight bag based digital relay, and/or a datalink. Additionally, or alternatively, a relay aircraft is associated with an audio relay capability. In this regard, for example, a relay aircraft that is associated with an audio relay capability is configured to communicate over the one or more communication channels 155 using one or more audio communication devices (e.g., a microphone, speaker, radio, etc.).

In some embodiments, the one or more other aircraft 115 include one aircraft capable of being a relay aircraft. For example, the first other aircraft 115A may be the only aircraft in the one or more other aircraft 115 that is capable of being a relay aircraft in the one or more other aircraft 115. In some embodiments, the one or more other aircraft 115 include more than one or aircraft capable of being a relay aircraft. For example, the first other aircraft 115A and the second other aircraft 115B may be capable of being a relay aircraft. In this regard, for example, when the one or more other aircraft 115 include more than one or aircraft capable of being a relay aircraft, the aviation operations apparatus may be configured to determine a relay aircraft that is the optimal aircraft in the one or more other aircraft 115 for serving as a relay aircraft. For example, if the first other aircraft 115A and the second other aircraft 115B are both capable of being a relay aircraft, the aviation operations apparatus may be configured to determine that the first other aircraft 115A is the relay aircraft if the first other aircraft 115A is better suited than the second other aircraft 115B for serving as the relay aircraft.

In some embodiments, the aviation operations apparatus (e.g., the mobile aviation operations apparatus 120, the onboard aviation operations apparatus 180, and/or the cloud-based aviation operations apparatus 140) is configured to determine a relay aircraft by applying aircraft operations data to a relay aircraft model. In some embodiments, the relay aircraft model is a data entity that describes parameters, hyper-parameters, and/or defined operations of a rules-based and/or machine learning model that is configured to determine a relay aircraft using aircraft operations data. In this regard, for example, the aviation operations apparatus may be configured to determine a relay aircraft by applying one or more aviation-related features associated with the one or more other aircraft 115 (e.g., the one or more aviation-related features indicated by aircraft operations data) to the relay aircraft model. For example, the aviation operations apparatus may be configured to determine a relay aircraft by applying one or more aviation-related features that indicate whether an aircraft in the one or more other aircraft 115 is in a line of sight of the first aircraft 110 to the relay aircraft model. In this regard, for example, a relay aircraft may be an aircraft that is in a line of sight of the first aircraft 110 (e.g., an aircraft may need to be in a line of sight of the first aircraft 110 to serve as a relay aircraft).

As another example, the aviation operations apparatus may be configured to determine a relay aircraft by applying one or more aviation-related features that indicate whether an aircraft in the one or more other aircraft 115 is in a line of sight of one or more of the one or more aviation operations control systems 125 to the relay aircraft model. In this regard, for example, a relay aircraft may be an aircraft that is in a line of sight of one or more of the one or more aviation operations control systems 125 (e.g., an aircraft may need to be in a line of sight of an aviation operations control system to serve as a relay aircraft). As another example, the aviation operations apparatus may be configured to determine a relay aircraft by applying one or more aviation-related features that indicate an altitude to the relay aircraft model. In this regard, for example, a relay aircraft may be an aircraft associated with a sufficient altitude for serving as a relay aircraft (e.g., a relay aircraft may need to be at a sufficient altitude such that communication channels are not blocked by the one or more obstacles 145).

As another example, the aviation operations apparatus may be configured to determine a relay aircraft by applying one or more aviation-related features that indicate a distance from the first aircraft 110 to the relay aircraft model. In this regard, for example, a relay aircraft may be an aircraft within a particular distance from the first aircraft 110 (e.g., a relay aircraft may need to be within a particular distance of the first aircraft 110 to serve as a relay aircraft). As another example, the aviation operations apparatus may be configured to determine a relay aircraft by applying one or more aviation-related features that indicate a flight plan to the relay aircraft model. In this regard, for example, a relay aircraft may be an aircraft that is adhering to a flight plan that keeps the aircraft within proximity of the first aircraft 110. As another example, the aviation operations apparatus may be configured to determine a relay aircraft by applying one or more aviation-related features that indicate a frequency being used to communicate with one or more of the one or more aviation operations control systems 125. In this regard, for example, a relay may be an aircraft that is using the same frequency as the first aircraft 110 for communicating with one or more of the one or more aviation operations control systems 125.

As another example, the aviation operations apparatus may be configured to determine a relay aircraft by applying one or more aviation-related features that indicate a direction an aircraft in the one or more other aircraft 115 is traveling relative to the first aircraft 110 to the relay aircraft model. In this regard, for example, a relay aircraft may be an aircraft that is travelling in approximately the same direction and/or the opposite direction as the first aircraft 110. As another example, the aviation operations apparatus may be configured to determine a relay aircraft by applying one or more aviation-related features that indicate a signal metric to the relay aircraft model. In this regard, for example, a relay aircraft may be an aircraft associated with a sufficient signal metric for serving as a relay aircraft. As another example, the aviation operations apparatus may be configured to determine a relay aircraft by applying one or more aviation-related features that indicate a position to the relay aircraft model. In this regard, for example, a relay aircraft may be an aircraft associated with a position in proximity to the first aircraft 110. As another example, the aviation operations apparatus may be configured to determine a relay aircraft by applying one or more aviation-related features that indicate an aircraft type to the relay aircraft model. In this regard, for example, a relay aircraft may be an aircraft that is the same type of aircraft as the first aircraft 110 (e.g., when the first aircraft 110 is an airplane the relay aircraft is also an airplane, when the first aircraft 110 is a helicopter the relay aircraft is also a helicopter, etc.).

In some embodiments, the aviation operations apparatus (e.g., the mobile aviation operations apparatus 120, the onboard aviation operations apparatus 180, and/or the cloud-based aviation operations apparatus 140) is configured to generate an other aircraft interface component 400. In some embodiments, the other aircraft interface component 400 includes one or more aircraft items 402. For example, the one or more aircraft items 402 may include a first aircraft item 402A, a second aircraft item 402B, a third aircraft item 402C, a fourth aircraft item 402D, and/or a fifth aircraft item 402E. In some embodiments, each of the one or more aircraft items 402 corresponds to one of the one or more other aircraft 115. For example, the first aircraft item 402A may correspond to the first other aircraft 115A, the second aircraft item 402B may correspond to the second other aircraft 115B, the third aircraft item 402C may correspond to the third other aircraft 115C, the fourth aircraft item 402D may correspond to the fourth other aircraft 115D, and/or the fifth aircraft item 402E may correspond to the fifth other aircraft 115E. In some embodiments, each of the one or more aircraft items 402 is selectable.

In some embodiments, the other aircraft interface component 400 is generated using aircraft operations data. In this regard, for example, the one or more aircraft items 402 may be configured to display representations of one or more aviation-related features associated with the one or more other aircraft 115 as indicated by the aircraft operations data. For example, the one or more aircraft items 402 may include a representation of an aviation-related feature that indicates an aircraft identification (e.g., a tail number). As another example, the one or more aircraft items 402 may include a representation of an aviation-related feature that indicates a signal metric (e.g., 6 out of 6 bars). As another example, the one or more aircraft items 402 may include a representation of an aviation-related feature that indicates an aircraft type (e.g., a symbol that indicates an airplane or a helicopter). As another example, the one or more aircraft items 402 may include a representation of an aviation-related feature that indicates a direction that the one or more other aircraft 115 are traveling relative to the first aircraft 110 (e.g., an orientation of a symbol that indicates an aircraft type).

In some embodiments, the aviation operations apparatus (e.g., the mobile aviation operations apparatus 120, the onboard aviation operations apparatus 180, and/or the cloud-based aviation operations apparatus 140) is configured to generate a relay aircraft interface component 500. In some embodiments, the relay aircraft interface component 500 corresponds to one of the one or more aircraft items 402. For example, the relay aircraft interface component 500 may correspond to the first aircraft item 402A. In some embodiments, the relay aircraft interface component 500 is generated in response to a selection of one of the one or more aircraft items 402. For example, the relay aircraft interface component 500 may be generated in response to a selection of the first aircraft item 402A.

In some embodiments, the relay aircraft interface component 500 includes one or more aircraft action items 506. In some embodiments, the one or more aircraft action items 506 includes a first aircraft action item 506A, a second aircraft action item 506B, and/or a third aircraft action item 506C. In some embodiments, the one or more aircraft action items 506 are selectable.

In some embodiments, the relay aircraft interface component 500 is generated using aircraft operations data and/or the determination of the relay aircraft using the relay aircraft model. In this regard, for example, the relay aircraft interface component 500 may be configured to display representations of one or more aviation-related features associated with the relay aircraft as indicated by the aircraft operations data. For example, the relay aircraft interface component 500 may include a representation of an aviation-related feature that indicates an aircraft identification (e.g., a tail number, such as VT-SRB). As another example, the relay aircraft interface component 500 may include a representation of an aviation-related feature that indicates an altitude (e.g., 1000 feet). As another example, the relay aircraft interface component 500 may include a representation of an aviation-related feature that indicates a position (e.g., N34E112). As another example, the relay aircraft interface component 500 may include a representation of an aviation-related feature that indicates a flight plan that includes a particular course (e.g., CRS: 232°). As another example, the relay aircraft interface component 500 may include a representation of an aviation-related feature that indicates a flight plan that includes a particular radial (e.g., 052°).

In some embodiments, the relay aircraft interface component 500 is configured to display a mapping interface element 502. In some embodiments, the mapping interface element 502 includes a representation 504 of the relay aircraft. In some embodiments, the mapping interface element 502 is configured to indicate the position of the relay aircraft using the representation 504 of the relay aircraft. In some embodiments, the mapping interface element 502 is configured to be updated in real-time. In this regard, for example, the position of the representation 504 of the relay aircraft in the mapping interface element 502 may be updated in real-time to reflect a changing position of the relay aircraft.

In some embodiments, the aviation operations apparatus (e.g., the mobile aviation operations apparatus 120, the onboard aviation operations apparatus 180, and/or the cloud-based aviation operations apparatus 140) is configured to cause the other aircraft interface component 400 to be rendered to an aviation operations interface 600. In some embodiments, the aviation operations apparatus is configured to cause the other aircraft interface component 400 to be automatically rendered to the aviation operations interface 600 in response to the aviation operations apparatus detecting the one or more other aircraft 115.

In some embodiments, the aviation operations apparatus (e.g., the mobile aviation operations apparatus 120, the onboard aviation operations apparatus 180, and/or the cloud-based aviation operations apparatus 140) is configured to cause the relay aircraft interface component 500 to be rendered to the aviation operations interface 600. In some embodiments, the aviation operations apparatus is configured cause the relay aircraft interface component 500 to be rendered to the aviation operations interface 600 in response to a selection of one of the one or more aircraft items 402. Additionally, or alternatively, the aviation operations apparatus is configured cause the relay aircraft interface component 500 to be automatically rendered to the aviation operations interface 600 in response to a determination of a relay aircraft. In some embodiments, the relay aircraft interface component 500 is rendered proximate the other aircraft interface component 400 on the aviation operations interface 600.

In some embodiments, the aviation operations apparatus (e.g., the mobile aviation operations apparatus 120, the onboard aviation operations apparatus 180, and/or the cloud-based aviation operations apparatus 140) is configured to cause a communication channel to be established with a relay aircraft (e.g., a second communication channel). For example, when the first other aircraft 115A is the relay aircraft, the aviation operations apparatus may be configured to cause a communication channel to be established between the first aircraft 110 and the first other aircraft 115A. In some embodiments, the communication channel between the first aircraft 110 and the relay aircraft is established in response to a selection of the first aircraft action item 506A.

In some embodiments, the aviation operations apparatus (e.g., the mobile aviation operations apparatus 120, the onboard aviation operations apparatus 180, and/or the cloud-based aviation operations apparatus 140) is configured to initiate performance of one or more aviation operation actions. In some embodiments, the aviation operations apparatus is configured to initiate performance of one or more aviation operation actions using a communication channel between the first aircraft 110 and the relay aircraft (e.g., a second communication channel of the one or more communication channels 155). In this regard, for example, the aviation operations apparatus is configured to initiate performance of one or more aviation operation actions when a communication channel between the first aircraft 110 and an aviation operations control system of the one or more aviation operations control systems 125 is unavailable. In this way, for example, the aviation operations apparatus is able to communicate with the one or more aviation operations control systems 125 even when the one or more obstacles are blocking a communication channel between the first aircraft 110 and the one or more aviation operations control systems 125.

In some embodiments, initiating performance of one or more aviation operation actions includes the aviation operations apparatus being configured to cause aircraft position data associated with the first aircraft 110 to be provided to one of the one or more aviation operations control systems 125 using the communication channel between the first aircraft 110 and the relay aircraft. In this regard, for example, the aviation operations apparatus may be configured to cause position data associated with the first aircraft 110 to be provided from the first aircraft 110 to the relay aircraft using the communication channel between the first aircraft 110 and the relay aircraft. Then, for example, the aviation operations apparatus may be configured to cause the position data to be provided from the relay aircraft to an aviation operations control system using a communication channel between the aviation operations control system and the relay aircraft. For example, the aviation operations apparatus may be configured to cause position data to be provided to the first other aircraft 115A (e.g., when the first other aircraft 115A is a relay aircraft) and then be provided from the first other aircraft 115A to the second very high frequency omnidirectional range station 125F.

In some embodiments, the aviation operations apparatus is configured to cause aircraft position data associated with the first aircraft 110 to be provided to one of the one or more aviation operations control systems 125 using the communication channel between the first aircraft 110 and the relay aircraft using the one or more onboard components 190. In some embodiments, position data includes one or more items of data indicative and/or representative of a position of the first aircraft 110. For example, position data may be indicative and/or representative of a position of the first aircraft 110 at a particular point in time, at a particular point in a flight plan, and/or the like. In some embodiments, the aviation operations apparatus is configured to cause aircraft position data associated with the first aircraft 110 to be provided to one of the one or more aviation operations control systems 125 using the communication channel between the first aircraft 110 and the relay aircraft in response to a selection of the second aircraft action item 506B.

In some embodiments, initiating performance of one or more aviation operation actions includes the aviation operations apparatus being configured to provide a message to a relay aircraft and/or the one or more aviation operations control systems 125 using the communication channel between the first aircraft 110 and the relay aircraft. For example, the aviation operations apparatus may be configured to provide a message that indicates which of the one or more aviation operations control systems 125 that the first aircraft 110 is trying to communicate with. As another example, the aviation operations apparatus may be configured to provide a message that indicates a flight plan that the first aircraft 110 is attempting to implement. As another example, the aviation operations apparatus may be configured to provide a message that indicates a weather phenomenon encountered by the first aircraft 110. As another example, the aviation operations apparatus may be configured to provide a message that includes a notice to airmen (e.g., a NOTAM). As another example, the aviation operations apparatus may be configured to provide a message that indicates a performance of the first aircraft 110 (e.g., fuel expenditure). In some embodiments, the aviation operations apparatus is configured to provide a message to a relay aircraft and/or the one or more aviation operations control systems 125 using the communication channel between the first aircraft 110 and the relay aircraft in response to a selection of the third aircraft action item 506C. In this regard, for example, a message provided by the aviation operations apparatus may include free text generated by an operator of the first aircraft 110 (e.g., a pilot) using the third aircraft action item 506C.

In some embodiments, initiating performance of one or more aviation operation actions includes the aviation operations apparatus being configured to receive an aviation operation command. In some embodiments, the aviation operation command is received via the communication channel between the first aircraft 110 and the relay aircraft. In some embodiments, the aviation operation command is generated by one of the one or more aviation operations control systems 125. In this regard, for example, the aviation operation command may be provided to the relay aircraft via a communication channel between the relay aircraft and one of the one or more aviation operations control systems 125.

In some embodiments, an aviation operation command may be a command, instruction, and/or directive associated with the first aircraft 110. For example, an aviation operation command may be a command, instruction, and/or directive for the first aircraft 110 to operate on a particular heading. As another example, an aviation operation command may be a command, instruction, and/or directive for the first aircraft 110 to operate at a particular altitude. As another example, an aviation operation command may be a command, instruction, and/or directive for the first aircraft 110 to operate at a particular speed. As another example, an aviation operation command may be a command, instruction, and/or directive for the first aircraft 110 to operate in accordance with a flight plan (e.g., what airport to land at, waypoints for the first aircraft 110, etc.).

In some embodiments, initiating performance of one or more aviation operation actions includes the aviation operations apparatus being configured to cause actuation of one or more of the one or more onboard components 190 of the first aircraft 110. In some embodiments, the aviation operations apparatus is configured to cause actuation of one or more of the one or more onboard components 190 of the first aircraft 110 based on an aviation operation command. For example, if an aviation operation command indicates a particular altitude for the first aircraft 110 to operate at, the aviation operations apparatus may be configured to cause actuation of one or more of the one or more onboard components 190 of the first aircraft 110 to cause the first aircraft 110 to operate at the altitude. As another example, if an aviation operation command indicates a particular heading for the first aircraft 110 to use, the aviation operations apparatus may be configured to cause actuation of one or more of the one or more onboard components 190 of the first aircraft 110 to cause the first aircraft 110 to use the heading. As another example, if an aviation operation command indicates a particular speed for the first aircraft 110 to operate at, the aviation operations apparatus may be configured to cause actuation of one or more of the one or more onboard components 190 of the first aircraft 110 to cause the first aircraft 110 to operate at the speed. As another example, if an aviation operation command indicates a particular flight plan for the first aircraft 110 to operate in accordance with, the aviation operations apparatus may be configured to cause actuation of one or more of the one or more onboard components 190 of the first aircraft 110 to cause the first aircraft 110 to operate in accordance with the flight plan.

In some embodiments, initiating performance of one or more aviation operation actions includes the aviation operations apparatus being configured to cause an aviation operation request from the first aircraft 110 to be provided to one of the one or more aviation operations control systems 125 using the communication channel between the first aircraft 110 and the relay aircraft. In this regard, for example, the aviation operations apparatus may be configured to cause an aviation operation request from the first aircraft 110 to be provided from the first aircraft 110 to the relay aircraft. Then, for example, the aviation operations apparatus may be configured to cause the aviation operation request to be provided from the relay aircraft to an aviation operations control system using a communication channel between the aviation operations control system and the relay aircraft. For example, the aviation operations apparatus may be configured to cause an aviation operation request to be provided to the first other aircraft 115A (e.g., when the first other aircraft 115A is a relay aircraft) and then be provided from the first other aircraft 115A to the second very high frequency omnidirectional range station 125F.

In some embodiments, an aviation operation request is a request from the first aircraft 110. In some embodiments, an aviation operation request is a request from the first aircraft to one or more of the one or more aviation operations control systems 125. For example, an aviation operation request may be a request from the first aircraft 110 for the first aircraft 110 to operate at a particular heading. As another example, an aviation operation request may be a request from the first aircraft 110 for the first aircraft 110 to operate at a particular speed. As another example, an aviation operation request may be a request from the first aircraft 110 for the first aircraft 110 to operate at a particular altitude. In some embodiments, an aviation operation request may cause an aviation operations control system to provide the first aircraft 110 with an aviation operation command.

In some embodiments, the aviation operations apparatus (e.g., the mobile aviation operations apparatus 120, the onboard aviation operations apparatus 180, and/or the cloud-based aviation operations apparatus 140) is configured to establish one or more additional communication channels with one or more other relay aircraft. In some embodiments, the aviation operations apparatus may be configured to establish one or more additional communication channels with one or more other relay aircraft in response to the communication channel between the first aircraft 110 and the relay aircraft becoming unavailable. In this regard, for example, due to the continuous movement of the first aircraft 110 and/or the one or more other aircraft 115, the communication channel between the first aircraft 110 and the relay aircraft may only be useable for a period of time. For example, the relay aircraft may eventually be blocked by the one or more obstacles 145 from the aviation operations control system that the first aircraft 110 is communicating with via the relay aircraft. In this regard, the aviation operations apparatus is configured to establish additional communication channels with one or more other relay aircraft such that the first aircraft 110 is able to maintain communication with the one or more aviation operations control systems 125. Said differently, for example, in order to ensure efficient and seamless communication with the one or more aviation operations control systems 125, the aviation operations apparatus may be configured to leverage multiple relay aircraft.

In some embodiments, establishing one or more additional communication channels with one or more other relay aircraft includes determining that a communication channel between the first aircraft 110 and the relay aircraft is unavailable. In some embodiments, establishing one or more additional communication channels with one or more other relay aircraft includes detecting one or more updated other aircraft using at least one second detection technique. In some embodiments, establishing one or more additional communication channels with one or more other relay aircraft includes determining an other relay aircraft from the one or more updated other aircraft by applying updated aircraft operations data to the relay aircraft model. In some embodiments, establishing one or more additional communication channels with one or more other relay aircraft includes causing one or more additional communication channels to be established between the first aircraft 110 and one or more other relay aircraft.

### Example Methods

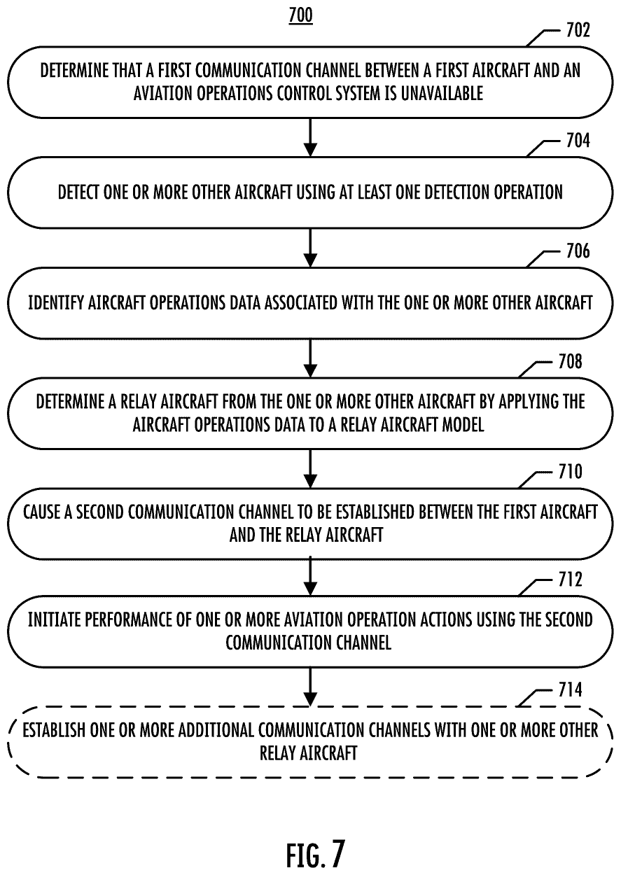

Referring now to FIG. 7, a flowchart providing an example method 700 is illustrated. In this regard, FIG. 7 illustrates operations that may be performed by the first aircraft 110, the one or more other aircraft 115, the one or more aviation operations control systems 125, the cloud-based aviation operations apparatus 140, the mobile aviation operations apparatus 120, the one or more onboard components 190, the onboard aviation operations apparatus 180, the one or more databases 170, and/or the like. In some embodiments, the method 700 includes operations for initiating performance of one or more aviation operation actions using a communication channel. In some embodiments, the example method 700 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700.

As shown in block 702, the method 700 includes determining that a first communication channel between a first aircraft and an aviation operations control system is unavailable. As described above, in some embodiments, the aviation operations apparatus is configured to determine that a communication channel is unavailable when the aviation operations apparatus is unable to receive signals, data, and/or the like from an aviation operations control system. For example, the aviation operations apparatus may be configured to expect to receive signals, data, and/or the like from an aviation operations control system in a particular time period or geographic location and, when the aviation operations apparatus does not receive signals, data, and/or the like from an aviation operations control system in the particular time period or geographic location, determine that the communication channel is unavailable. Additionally, or alternatively, the aviation operations apparatus is configured to determine that a communication channel is unavailable when the aviation operations apparatus transmits signals, data, and/or the like to an aviation operations control system and does not receive a response.

As shown in block 704, the method 700 includes detecting one or more other aircraft using at least one detection operation. As described above, in some embodiments, the one or more other aircraft are in proximity to the first aircraft. In this regard, for example, the aviation operations apparatus may be configured to detect the one or more other aircraft when the one or more other aircraft are in proximity to the first aircraft. In some embodiments, the one or more other aircraft are in proximity to the first aircraft when the one or more other aircraft are within a predefined distance of the first aircraft. For example, the one or more other aircraft are in proximity to the first aircraft when the one or more other aircraft are within ninety miles of the first aircraft.

As shown in block 706, the method 700 includes identifying aircraft operations data associated with the one or more other aircraft. As described above, in some embodiments, the aircraft operations data may be associated with the one or more other aircraft. In some embodiments, identifying aircraft operations data includes the aviation operations apparatus being configured to receive aircraft operations data from one or more of the one or more other aircraft. In some embodiments, the aviation operations apparatus is configured to receive aircraft operations data from one or more of the one or more other aircraft using the one or more onboard components. In some embodiments, one or more transponders of the one or more other aircraft are configured to provide aircraft operations data to the first aircraft. In some embodiments, identifying aircraft operations data includes the aviation operations apparatus being configured to access aircraft operations data from the one or more databases. In some embodiments, the aviation operations apparatus is configured to generate aviation operations data. For example, the aviation operations apparatus may be configured to generate aviation operations data using transponder data and/or audio data.

In some embodiments, aircraft operations data includes one or more items of data indicative and/or representative of one or more aviation-related features associated with the one or more other aircraft. In some embodiments, the one or more aviation-related features associated with the one or more other aircraft indicate whether an aircraft in the one or more other aircraft is in a line of sight of the first aircraft. In some embodiments, for example, the one or more other aircraft are in a line of sight of the first aircraft when one or more of the one or more obstacles are not blocking a line of sight between the first aircraft and the one or more other aircraft. For example, the one or more aviation-related features may indicate that the first other aircraft is in a line of sight of the first aircraft.

In some embodiments, the one or more aviation-related features associated with the one or more other aircraft indicate whether an aircraft in the one or more other aircraft is in a line of sight of one or more of the one or more aviation operations control systems. In some embodiments, for example, an aircraft in the one or more other aircraft is in a line of sight of an aviation operations control system when the one or more obstacles are not blocking a line of sight between the aircraft and the aviation operations control system. For example, the one or more aviation-related features may indicate that the sixth other aircraft is in a line of sight with the first GPS satellite. As another example, the one or more aviation-related features may indicate that the sixth other aircraft is in a line of sight with the first very high frequency omnidirectional range station. As another example, the one or more aviation-related features may indicate that the sixth other aircraft is in a line of sight with the first GPS satellite, the second GPS satellite, the third GPS satellite, and/or the fourth GPS satellite. As another example, the one or more aviation-related features may indicate that the fifth other aircraft is in a line of sight with the first very high frequency omnidirectional range station. As another example, the one or more aviation-related features may indicate that the second other aircraft is in a line of sight with the first very high frequency omnidirectional range station and/or the second very high frequency omnidirectional range station.

In some embodiments, the one or more aviation-related features associated with the one or more other aircraft indicate an altitude. For example, the one or more aviation-related features may indicate that the first other aircraft is at an altitude of approximately 27,000 feet. As another example, the one or more aviation-related features may indicate that the second other aircraft is at an altitude of approximately 27,000 feet. As another example, the one or more aviation-related features may indicate that the third other aircraft is at an altitude of approximately 6,000 feet. As another example, the one or more aviation-related features may indicate that the fourth other aircraft is at an altitude of approximately 4,000 feet. As another example, the one or more aviation-related features may indicate that the fifth other aircraft is at an altitude of approximately 10,000 feet. As another example, the one or more aviation-related features may indicate that the sixth other aircraft is at an altitude of approximately 20,000 feet.

In some embodiments, the one or more aviation-related features associated with the one or more other aircraft indicate a distance from the first aircraft and/or a distance from another of the one or more other aircraft. For example, the one or more aviation-related features may indicate that the first other aircraft is approximately 195 nautical miles from the first aircraft. As another example, the one or more aviation-related features may indicate that the sixth other aircraft is approximately 225 nautical miles from the first other aircraft.

In some embodiments, the one or more aviation-related features associated with the one or more other aircraft indicate a flight plan. For example, the one or more aviation-related features may indicate that the first other aircraft is implementing a flight plan that includes landing at a particular airport. As another example, the one or more aviation-related features may indicate that the second other aircraft is implementing a flight plan that includes a planned heading and/or altitude change at a particular point in a flight. As another example, the one or more aviation-related features may indicate that the first other aircraft is implementing a flight plan that includes a particular course (e.g., CRS: 232°). As another example, the one or more aviation-related features may indicate that the first other aircraft is implementing a flight plan that includes a particular radial (e.g., 052°).

In some embodiments, the one or more aviation-related features associated with the one or more other aircraft indicate a frequency the one or more other aircraft are using to communicate with one or more of the one or more aviation operations control systems (e.g., via one or more of the one or more communication channels). For example, the one or more aviation-related features may indicate that the first other aircraft is communicating with the second GPS satellite using a frequency of 184.75. In this regard, for example, the first GPS satellite, the second GPS satellite, the third GPS satellite, and/or the fourth GPS satellite may be configured to operate using a frequency of 184.75. As another example, the one or more aviation-related features may indicate that the fifth other aircraft is communicating with the first very high frequency omnidirectional range station using a frequency of 118.45. In this regard, for example, the first very high frequency omnidirectional range station may be configured to operate using a frequency of 118.45. As another example, the one or more aviation-related features may indicate that the first other aircraft is communicating with the second very high frequency omnidirectional range station using a frequency of 119.45. In this regard, for example, the second very high frequency omnidirectional range station may be configured to operate using a frequency of 119.45.

In some embodiments, the one or more aviation-related features associated with the one or more other aircraft indicate a direction that the one or more other aircraft are traveling relative to the first aircraft. For example, the one or more aviation-related features may indicate that the first other aircraft is heading in approximately the opposite direction to the first aircraft. As another example, the one or more aviation-related features may indicate that the second other aircraft is heading in the approximately the same direction and/or the opposite direction as the first aircraft.

In some embodiments, the one or more aviation-related features associated with the one or more other aircraft indicate a signal metric. In some embodiments, a signal metric may be indicative of an aircraft's capability for communicating over the one or more communication channels (e.g., how far can an aircraft communicate over a communication channel). For example, the one or more aviation-related features may indicate that the first other aircraft is associated with a signal metric of 5. As another example, the one or more aviation-related features may indicate that the third other aircraft is associated with a signal metric of 2.

In some embodiments, the one or more aviation-related features associated with the one or more other aircraft indicate an aircraft identification. In some embodiments, an aircraft identification may be a tail number associated with an aircraft. For example, the one or more aviation-related features may indicate that the first other aircraft is associated with an aircraft identification of VT-SRB. In some embodiments, the one or more aviation-related features associated with the one or more other aircraft indicate a position of an aircraft in the one or more other aircraft. For example, the one or more aviation-related features may indicate that the first other aircraft is associated with a first position (N34E112). In some embodiments, the one or more aviation-related features associated with the one or more other aircraft indicate an aircraft type. For example, the one or more aviation-related features may indicate that the first other aircraft is an airplane. As another example, the one or more aviation-related features may indicate that the third other aircraft is a helicopter.

As shown in block 708, the method 700 includes determining a relay aircraft from the one or more other aircraft by applying the aircraft operations data to a relay aircraft model.

As described above, in some embodiments, the aviation operations apparatus is configured to determine a relay aircraft from the one or more other aircraft. In some embodiments, a relay aircraft is an aircraft from the one or more other aircraft through which the first aircraft can communicate with one or more of the one or more aviation operations control systems. For example, the first other aircraft may be an aircraft through which the first aircraft can communicate with the second very high frequency omnidirectional range station. Said differently, for example, when a communication channel between the first aircraft and an aviation operations control system is unavailable (e.g., due to the one or more obstacles), a relay aircraft may be used by the first aircraft to facilitate communication with one or more of the one or more aviation operations control systems. In this regard, for example, at least one communication channel of the one or more communication channels between a relay aircraft and an aviation operations control system may be available (e.g., not blocked by obstacles).

In some embodiments, a relay aircraft is associated with a digital relay capability. In this regard, for example, a relay aircraft that is associated with a digital relay capability is configured to communicate over the one or more communication channels using a transponder, an electronic flight bag based digital relay, and/or a datalink. Additionally, or alternatively, a relay aircraft is associated with an audio relay capability. In this regard, for example, a relay aircraft that is associated with an audio relay capability is configured to communicate over the one or more communication channels using one or more audio communication devices (e.g., a microphone, speaker, radio, etc.).

In some embodiments, the one or more other aircraft include one aircraft capable of being a relay aircraft. For example, the first other aircraft may be the only aircraft in the one or more other aircraft that is capable of being a relay aircraft in the one or more other aircraft. In some embodiments, the one or more other aircraft include more than one or aircraft capable of being a relay aircraft. For example, the first other aircraft and the second other aircraft may be capable of being a relay aircraft. In this regard, for example, when the one or more other aircraft include more than one or aircraft capable of being a relay aircraft, the aviation operations apparatus may be configured to determine a relay aircraft that is the optimal aircraft in the one or more other aircraft for serving as a relay aircraft. For example, if the first other aircraft and the second other aircraft are both capable of being a relay aircraft, the aviation operations apparatus may be configured to determine that the first other aircraft is the relay aircraft if the first other aircraft is better suited than the second other aircraft for serving as the relay aircraft.

In some embodiments, the relay aircraft model is a data entity that describes parameters, hyper-parameters, and/or defined operations of a rules-based and/or machine learning model that is configured to determine a relay aircraft using aircraft operations data. In this regard, for example, the aviation operations apparatus may be configured to determine a relay aircraft by applying one or more aviation-related features associated with the one or more other aircraft (e.g., the one or more aviation-related features indicated by aircraft operations data) to the relay aircraft model. For example, the aviation operations apparatus may be configured to determine a relay aircraft by applying one or more aviation-related features that indicate whether an aircraft in the one or more other aircraft is in a line of sight of the first aircraft to the relay aircraft model. In this regard, for example, a relay aircraft may be an aircraft that is in a line of sight of the first aircraft (e.g., an aircraft may need to be in a line of sight of the first aircraft to serve as a relay aircraft).

As another example, the aviation operations apparatus may be configured to determine a relay aircraft by applying one or more aviation-related features that indicate whether an aircraft in the one or more other aircraft is in a line of sight of one or more of the one or more aviation operations control systems to the relay aircraft model. In this regard, for example, a relay aircraft may be an aircraft that is in a line of sight of one or more of the one or more aviation operations control systems (e.g., an aircraft may need to be in a line of sight of an aviation operations control system to serve as a relay aircraft). As another example, the aviation operations apparatus may be configured to determine a relay aircraft by applying one or more aviation-related features that indicate an altitude to the relay aircraft model. In this regard, for example, a relay aircraft may be an aircraft associated with a sufficient altitude for serving as a relay aircraft (e.g., a relay aircraft may need to be at a sufficient altitude such that communication channels are not blocked by the one or more obstacles).

As another example, the aviation operations apparatus may be configured to determine a relay aircraft by applying one or more aviation-related features that indicate a distance from the first aircraft to the relay aircraft model. In this regard, for example, a relay aircraft may be an aircraft within a particular distance from the first aircraft (e.g., a relay aircraft may need to be within a particular distance of the first aircraft to serve as a relay aircraft). As another example, the aviation operations apparatus may be configured to determine a relay aircraft by applying one or more aviation-related features that indicate a flight plan to the relay aircraft model. In this regard, for example, a relay aircraft may be an aircraft that is adhering to a flight plan that keeps the aircraft within proximity of the first aircraft. As another example, the aviation operations apparatus may be configured to determine a relay aircraft by applying one or more aviation-related features that indicate a frequency being used to communicate with one or more of the one or more aviation operations control systems. In this regard, for example, a relay may be an aircraft that is using the same frequency as the first aircraft for communicating with one or more of the one or more aviation operations control systems.

As another example, the aviation operations apparatus may be configured to determine a relay aircraft by applying one or more aviation-related features that indicate a direction an aircraft in the one or more other aircraft is traveling relative to the first aircraft to the relay aircraft model. In this regard, for example, a relay aircraft may be an aircraft that is travelling in approximately the same direction and/or the opposite direction as the first aircraft. As another example, the aviation operations apparatus may be configured to determine a relay aircraft by applying one or more aviation-related features that indicate a signal metric to the relay aircraft model. In this regard, for example, a relay aircraft may be an aircraft associated with a sufficient signal metric for serving as a relay aircraft. As another example, the aviation operations apparatus may be configured to determine a relay aircraft by applying one or more aviation-related features that indicate a position to the relay aircraft model. In this regard, for example, a relay aircraft may be an aircraft associated with a position in proximity to the first aircraft. As another example, the aviation operations apparatus may be configured to determine a relay aircraft by applying one or more aviation-related features that indicate an aircraft type to the relay aircraft model. In this regard, for example, a relay aircraft may be an aircraft that is the same type of aircraft as the first aircraft (e.g., when the first aircraft is an airplane the relay aircraft is also an airplane, when the first aircraft is a helicopter the relay aircraft is also a helicopter, etc.).

As shown in block 710, the method 700 includes causing a second communication channel to be established between the first aircraft and the relay aircraft. As described above, for example, when the first other aircraft is the relay aircraft, the aviation operations apparatus may be configured to cause a communication channel to be established between the first aircraft and the first other aircraft. In some embodiments, the communication channel between the first aircraft and the relay aircraft is established in response to a selection of the first aircraft action item.

As shown in block 712, the method 700 includes initiating performance of one or more aviation operation actions using the second communication channel. As described above, in some embodiments, the aviation operations apparatus is configured to initiate performance of one or more aviation operation actions using a communication channel between the first aircraft and the relay aircraft (e.g., a second communication channel of the one or more communication channels). In this regard, for example, the aviation operations apparatus is configured to initiate performance of one or more aviation operation actions when a communication channel between the first aircraft and an aviation operations control system of the one or more aviation operations control systems is unavailable. In this way, for example, the aviation operations apparatus is able to communicate with the one or more aviation operations control systems even when the one or more obstacles are blocking a communication channel between the first aircraft and the one or more aviation operations control systems.

As shown in optional block 714, the method 700 optionally includes establishing one or more additional communication channels with one or more other relay aircraft. As described above, in some embodiments, the aviation operations apparatus may be configured to establish one or more additional communication channels with one or more other relay aircraft in response to the communication channel between the first aircraft and the relay aircraft becoming unavailable. In this regard, for example, due to the continuous movement of the first aircraft and/or the one or more other aircraft, the communication channel between the first aircraft and the relay aircraft may only be useable for a period of time. For example, the relay aircraft may eventually be blocked by the one or more obstacles from the aviation operations control system that the first aircraft is communicating with via the relay aircraft. In this regard, the aviation operations apparatus is configured to establish additional communication channels with one or more other relay aircraft such that the first aircraft is able to maintain communication with the one or more aviation operations control systems. Said differently, for example, in order to ensure efficient and seamless communication with the one or more aviation operations control systems, the aviation operations apparatus may be configured to leverage multiple relay aircraft.

In some embodiments, establishing one or more additional communication channels with one or more other relay aircraft includes determining that a communication channel between the first aircraft and the relay aircraft is unavailable. In some embodiments, establishing one or more additional communication channels with one or more other relay aircraft includes detecting one or more updated other aircraft using at least one second detection technique. In some embodiments, establishing one or more additional communication channels with one or more other relay aircraft includes determining an other relay aircraft from the one or more updated other aircraft by applying updated aircraft operations data to the relay aircraft model. In some embodiments, establishing one or more additional communication channels with one or more other relay aircraft includes causing one or more additional communication channels to be established between the first aircraft and one or more other relay aircraft.

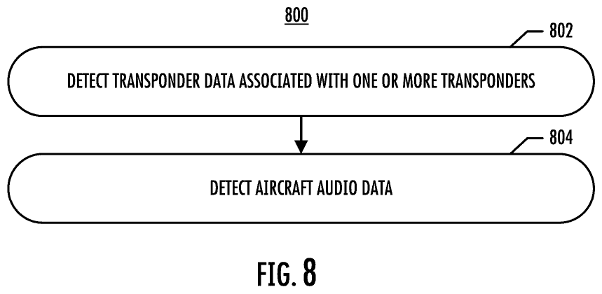

Referring now to FIG. 8, a flowchart providing an example method 800 is illustrated. In this regard, FIG. 8 illustrates operations that may be performed by the first aircraft 110, the one or more other aircraft 115, the one or more aviation operations control systems 125, the cloud-based aviation operations apparatus 140, the mobile aviation operations apparatus 120, the one or more onboard components 190, the onboard aviation operations apparatus 180, the one or more databases 170, and/or the like. In some embodiments, the method 800 includes operations for performing at least one detection operation. In some embodiments, the example method 800 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 800.

As shown in block 802, the method 800 includes detecting transponder data associated with one or more transponders. As described above, for example, the aviation operations apparatus may be configured to detect transponder data using one or more of the one or more onboard components of the first aircraft. In some embodiments, each of the one or more other aircraft are associated with one or more of the one or more transponders. In this regard, for example, one or more of the one or more transponders may be physically located on one or more of the one or more other aircraft. For example, a first transponder of the one or more transponders may be physically located on the first other aircraft of the one or more other aircraft.

In some embodiments, transponder data includes one or more items of data indicative and/or representative of a signal and/or information associated with a transponder. In this regard, for example, transponder data may be associated with one or more transponders. In some embodiments, the one or more transponders includes a Mode-A transponder. In some embodiments, a detection operation includes detecting transponder data that was generated and/or provided by a Mode-A transponder. In some embodiments, the one or more transponders includes a Mode-C transponder. In some embodiments, a detection operation includes detecting transponder data that was generated and/or provided by a Mode-C transponder. In some embodiments, the one or more transponders includes a Mode-S transponder. In some embodiments, a detection operation includes detecting transponder data that was generated and/or provided by a Mode-S transponder. In some embodiments, the one or more transponders includes an ADS-B transponder. In some embodiments, a detection operation includes detecting transponder data that was generated and/or provided by an ADS-B transponder.

As shown in block 804, the method 800 includes detecting aircraft audio data. As described above, in some embodiments, aircraft audio data includes one or more items of data indicative and/or representative of audio associated with one or more of the one or more other aircraft. In this regard, for example, aircraft audio data may be generated and/or provided by one or more of the one or more other aircraft. For example, aircraft audio data may include one or more items of data indicative and/or representative of a pilot speaking into communications equipment associated with one or more of the one or more other aircraft (e.g., a pilot speaking a location into communications equipment associated with one or more of the one or more other aircraft).

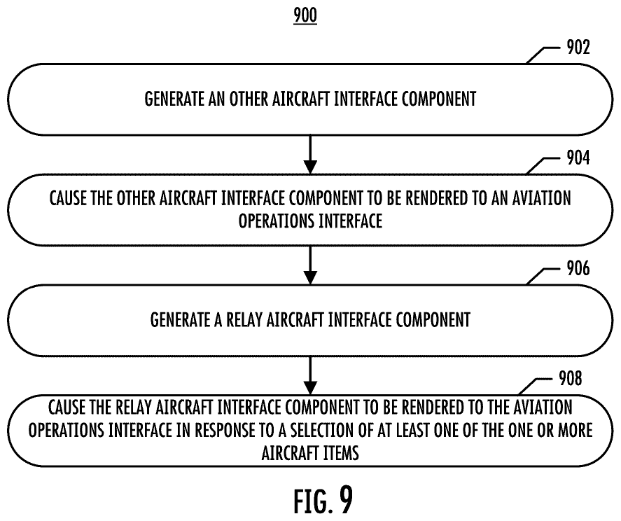

Referring now to FIG. 9, a flowchart providing an example method 900 is illustrated. In this regard, FIG. 9 illustrates operations that may be performed by the first aircraft 110, the one or more other aircraft 115, the one or more aviation operations control systems 125, the cloud-based aviation operations apparatus 140, the mobile aviation operations apparatus 120, the one or more onboard components 190, the onboard aviation operations apparatus 180, the one or more databases 170, and/or the like. In some embodiments, the method 900 includes operations for generating one or more interface components. In some embodiments, the example method 900 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 900.

As shown in block 902, the method 900 includes generating an other aircraft interface component. As described above, in some embodiments, the other aircraft interface component includes one or more aircraft items. For example, the one or more aircraft items may include a first aircraft item, a second aircraft item, a third aircraft item, a fourth aircraft item, and/or a fifth aircraft item. In some embodiments, each of the one or more aircraft items corresponds to one of the one or more other aircraft. For example, the first aircraft item may correspond to the first other aircraft, the second aircraft item may correspond to the second other aircraft, the third aircraft item may correspond to the third other aircraft, the fourth aircraft item may correspond to the fourth other aircraft, and/or the fifth aircraft item may correspond to the fifth other aircraft. In some embodiments, each of the one or more aircraft items is selectable.

In some embodiments, the other aircraft interface component is generated using aircraft operations data. In this regard, for example, the one or more aircraft items may be configured to display representations of one or more aviation-related features associated with the one or more other aircraft as indicated by the aircraft operations data. For example, the one or more aircraft items may include a representation of an aviation-related feature that indicates an aircraft identification (e.g., a tail number). As another example, the one or more aircraft items may include a representation of an aviation-related feature that indicates a signal metric (e.g., 6 out of 6 bars). As another example, the one or more aircraft items may include a representation of an aviation-related feature that indicates an aircraft type (e.g., a symbol that indicates an airplane or a helicopter). As another example, the one or more aircraft items may include a representation of an aviation-related feature that indicates a direction that the one or more other aircraft are traveling relative to the first aircraft (e.g., an orientation of a symbol that indicates an aircraft type).

As shown in block 904, the method 900 includes causing the other aircraft interface component to be rendered to an aviation operations interface. As described above, in some embodiments, the aviation operations apparatus is configured to cause the other aircraft interface component to be automatically rendered to the aviation operations interface 600 in response to the aviation operations apparatus detecting the one or more other aircraft.

As shown in block 906, the method 900 includes generating a relay aircraft interface component. As described above, in some embodiments, the relay aircraft interface component corresponds to one of the one or more aircraft items. For example, the relay aircraft interface component may correspond to the first aircraft item. In some embodiments, the relay aircraft interface component is generated in response to a selection of one of the one or more aircraft items. For example, the relay aircraft interface component may be generated in response to a selection of the first aircraft item.

In some embodiments, the relay aircraft interface component includes one or more aircraft action items. In some embodiments, the one or more aircraft action items includes a first aircraft action item, a second aircraft action item, and/or a third aircraft action item. In some embodiments, the one or more aircraft action items are selectable.

In some embodiments, the relay aircraft interface component is generated using aircraft operations data and/or the determination of the relay aircraft using the relay aircraft model. In this regard, for example, the relay aircraft interface component may be configured to display representations of one or more aviation-related features associated with the relay aircraft as indicated by the aircraft operations data. For example, the relay aircraft interface component may include a representation of an aviation-related feature that indicates an aircraft identification (e.g., a tail number, such as VT-SRB). As another example, the relay aircraft interface component may include a representation of an aviation-related feature that indicates an altitude (e.g., 1000 feet). As another example, the relay aircraft interface component may include a representation of an aviation-related feature that indicates a position (e.g., N34E112). As another example, the relay aircraft interface component may include a representation of an aviation-related feature that indicates a flight plan that includes a particular course (e.g., CRS: 232°). As another example, the relay aircraft interface component may include a representation of an aviation-related feature that indicates a flight plan that includes a particular radial (e.g., 052°).

In some embodiments, the relay aircraft interface component is configured to display a mapping interface element. In some embodiments, the mapping interface element includes a representation of the relay aircraft. In some embodiments, the mapping interface element is configured to indicate the position of the relay aircraft using the representation of the relay aircraft. In some embodiments, the mapping interface element is configured to be updated in real-time. In this regard, for example, the position of the representation of the relay aircraft in the mapping interface element may be updated in real-time to reflect a changing position of the relay aircraft.

As shown in block 908, the method 900 includes causing the relay aircraft interface component to be rendered to the aviation operations interface in response to a selection of at least one of the one or more aircraft items. As described above, additionally, or alternatively, the aviation operations apparatus is configured cause the relay aircraft interface component to be automatically rendered to the aviation operations interface 600 in response to a determination of a relay aircraft. In some embodiments, the relay aircraft interface component is rendered proximate the other aircraft interface component on the aviation operations interface 600.

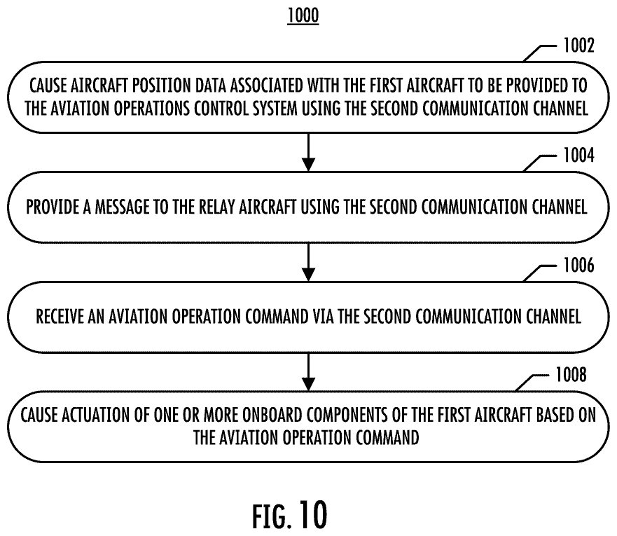

Referring now to FIG. 10, a flowchart providing an example method 1000 is illustrated. In this regard, FIG. 10 illustrates operations that may be performed by the first aircraft 110, the one or more other aircraft 115, the one or more aviation operations control systems 125, the cloud-based aviation operations apparatus 140, the mobile aviation operations apparatus 120, the one or more onboard components 190, the onboard aviation operations apparatus 180, the one or more databases 170, and/or the like. In some embodiments, the method 1000 includes operations for initiating performance of one or more aviation operation actions. In some embodiments, the example method 1000 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1000.

As shown in block 1002, the method 1000 includes causing aircraft position data associated with the first aircraft to be provided to the aviation operations control system using the second communication channel. As described above, in some embodiments, for example, the aviation operations apparatus may be configured to cause position data associated with the first aircraft to be provided from the first aircraft to the relay aircraft using the communication channel between the first aircraft and the relay aircraft. Then, for example, the aviation operations apparatus may be configured to cause the position data to be provided from the relay aircraft to an aviation operations control system using a communication channel between the aviation operations control system and the relay aircraft. For example, the aviation operations apparatus may be configured to cause position data to be provided to the first other aircraft (e.g., when the first other aircraft is a relay aircraft) and then be provided from the first other aircraft to the second very high frequency omnidirectional range station.

In some embodiments, the aviation operations apparatus is configured to cause aircraft position data associated with the first aircraft to be provided to one of the one or more aviation operations control systems using the communication channel between the first aircraft and the relay aircraft using the one or more onboard components. In some embodiments, position data includes one or more items of data indicative and/or representative of a position of the first aircraft. For example, position data may be indicative and/or representative of a position of the first aircraft at a particular point in time, at a particular point in a flight plan, and/or the like. In some embodiments, the aviation operations apparatus is configured to cause aircraft position data associated with the first aircraft to be provided to one of the one or more aviation operations control systems using the communication channel between the first aircraft and the relay aircraft in response to a selection of the second aircraft action item.

As shown in block 1004, the method 1000 includes providing a message to the relay aircraft using the second communication channel. As described above, additionally, or alternatively, a message may be provided to the one or more aviation operations control systems using the communication channel between the first aircraft and the relay aircraft. For example, the aviation operations apparatus may be configured to provide a message that indicates which of the one or more aviation operations control systems that the first aircraft is trying to communicate with. As another example, the aviation operations apparatus may be configured to provide a message that indicates a weather phenomenon encountered by the first aircraft. As another example, the aviation operations apparatus may be configured to provide a message that includes a notice to airmen (e.g., a NOTAM). As another example, the aviation operations apparatus may be configured to provide a message that indicates a performance of the first aircraft. As another example, the aviation operations apparatus may be configured to provide a message that indicates a flight plan that the first aircraft is attempting to implement. In some embodiments, the aviation operations apparatus is configured to provide a message to a relay aircraft and/or the one or more aviation operations control systems using the communication channel between the first aircraft and the relay aircraft in response to a selection of the third aircraft action item. In this regard, for example, a message provided by the aviation operations apparatus may include free text generated by an operator of the first aircraft (e.g., a pilot) using the third aircraft action item.

As shown in block 1006, the method 1000 includes receiving an aviation operation command via the second communication channel. As described above, in some embodiments, the aviation operation command is received via the communication channel between the first aircraft and the relay aircraft. In some embodiments, the aviation operation command is generated by one of the one or more aviation operations control systems. In this regard, for example, the aviation operation command may be provided to the relay aircraft via a communication channel between the relay aircraft and one of the one or more aviation operations control systems.

In some embodiments, an aviation operation command may be a command, instruction, and/or directive associated with the first aircraft. For example, an aviation operation command may be a command, instruction, and/or directive for the first aircraft to operate on a particular heading. As another example, an aviation operation command may be a command, instruction, and/or directive for the first aircraft to operate at a particular altitude. As another example, an aviation operation command may be a command, instruction, and/or directive for the first aircraft to operate at a particular speed. As another example, an aviation operation command may be a command, instruction, and/or directive for the first aircraft to operate in accordance with a flight plan (e.g., what airport to land at, waypoints for the first aircraft, etc.).

As shown in block 1008, the method 1000 includes causing actuation of one or more onboard components of the first aircraft based on the aviation operation command. As described above, in some embodiments, the aviation operations apparatus is configured to cause actuation of one or more of the one or more onboard components of the first aircraft based on an aviation operation command. For example, if an aviation operation command indicates a particular altitude for the first aircraft to operate at, the aviation operations apparatus may be configured to cause actuation of one or more of the one or more onboard components of the first aircraft to cause the first aircraft to operate at the altitude. As another example, if an aviation operation command indicates a particular heading for the first aircraft to use, the aviation operations apparatus may be configured to cause actuation of one or more of the one or more onboard components of the first aircraft to cause the first aircraft to use the heading. As another example, if an aviation operation command indicates a particular speed for the first aircraft to operate at, the aviation operations apparatus may be configured to cause actuation of one or more of the one or more onboard components of the first aircraft to cause the first aircraft to operate at the speed. As another example, if an aviation operation command indicates a particular flight plan for the first aircraft to operate in accordance with, the aviation operations apparatus may be configured to cause actuation of one or more of the one or more onboard components of the first aircraft to cause the first aircraft to operate in accordance with the flight plan.

In some embodiments, initiating performance of one or more aviation operation actions includes the aviation operations apparatus being configured to cause an aviation operation request from the first aircraft to be provided to one of the one or more aviation operations control systems using the communication channel between the first aircraft and the relay aircraft. In this regard, for example, the aviation operations apparatus may be configured to cause an aviation operation request from the first aircraft to be provided from the first aircraft to the relay aircraft. Then, for example, the aviation operations apparatus may be configured to cause the aviation operation request to be provided from the relay aircraft to an aviation operations control system using a communication channel between the aviation operations control system and the relay aircraft. For example, the aviation operations apparatus may be configured to cause an aviation operation request to be provided to the first other aircraft (e.g., when the first other aircraft is a relay aircraft) and then be provided from the first other aircraft to the second very high frequency omnidirectional range station.

In some embodiments, an aviation operation request is a request from the first aircraft. In some embodiments, an aviation operation request is a request from the first aircraft to one or more of the one or more aviation operations control systems. For example, an aviation operation request may be a request from the first aircraft for the first aircraft to operate at a particular heading. As another example, an aviation operation request may be a request from the first aircraft for the first aircraft to operate at a particular speed. As another example, an aviation operation request may be a request from the first aircraft for the first aircraft to operate at a particular altitude. In some embodiments, an aviation operation request may cause an aviation operations control system to provide the first aircraft with an aviation operation command.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this specification contains many specific embodiment and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A method comprising:
determining that a first communication channel between a first aircraft and an aviation operations control system is unavailable;
detecting one or more other aircraft using at least one detection operation, wherein the one or more other aircraft are in proximity to the first aircraft;
identifying aircraft operations data associated with the one or more other aircraft;
determining a relay aircraft from the one or more other aircraft by applying the aircraft operations data to a relay aircraft model, wherein the aircraft operations data is indicative of one or more aviation-related features associated with the one or more other aircraft;
causing a second communication channel to be established between the first aircraft and the relay aircraft; and
initiating performance of one or more aviation operation actions using the second communication channel.

2. The method of claim 1, wherein the aviation operations control system comprises a very high frequency omnidirectional range station.

3. The method of claim 1, wherein the aviation operations control system comprises a global positioning system (GPS) satellite.

4. The method of claim 1, wherein the aviation operations control system comprises an air traffic control system.

5. The method of claim 1, wherein the at least one detection operation comprises:
detecting transponder data associated with one or more transponders.

6. The method of claim 5, wherein the one or more transponders comprise a Mode-A transponder, a Mode-B transponder, a Mode-C transponder, or an ADS-B transponder.

7. The method of claim 5, wherein a first transponder of the one or more transponders is physically located on a first other aircraft of the one or more other aircraft.

8. The method of claim 1, wherein the at least one detection operation comprises:
detecting aircraft audio data.

9. The method of claim 1, further comprising:
generating an other aircraft interface component, wherein the other aircraft interface component comprises one or more aircraft items, wherein each of the one or more aircraft items is associated with one of the one or more other aircraft; and
causing the other aircraft interface component to be rendered to an aviation operations interface.

10. The method of claim 9, further comprising:
generating a relay aircraft interface component, wherein the relay aircraft interface component comprises one or more aircraft action items; and
causing the relay aircraft interface component to be rendered to the aviation operations interface in response to a selection of at least one of the one or more aircraft items.

11. The method of claim 1, wherein initiating performance of the one or more aviation operation actions comprises:
causing aircraft position data associated with the first aircraft to be provided to the aviation operations control system using the second communication channel.

12. The method of claim 1, wherein initiating performance of the one or more aviation operation actions comprises:
providing a message to the relay aircraft using the second communication channel.

13. The method of claim 1, wherein initiating performance of the one or more aviation operation actions comprises:
receiving an aviation operation command via the second communication channel; and
causing actuation of one or more onboard components of the first aircraft based on the aviation operation command.

14. The method of claim 1, further comprising:
establishing one or more additional communication channels with one or more other relay aircraft.

15. The method of claim 1, wherein the relay aircraft is associated with a digital relay capability.

16. An apparatus comprising memory and one or more processors communicatively coupled to the memory, the one or more processors configured to:
determine that a first communication channel between a first aircraft and an aviation operations control system is unavailable;
detect one or more other aircraft using at least one detection operation, wherein the one or more other aircraft are in proximity to the first aircraft;
identify aircraft operations data associated with the one or more other aircraft;
determine a relay aircraft from the one or more other aircraft by applying the aircraft operations data to a relay aircraft model, wherein the aircraft operations data is indicative of one or more aviation-related features associated with the one or more other aircraft;
cause a second communication channel to be established between the first aircraft and the relay aircraft; and
initiate performance of one or more aviation operation actions using the second communication channel.

17. The apparatus of claim 16, wherein the aviation operations control system comprises a very high frequency omnidirectional range station, a global positioning system (GPS) satellite, or an air traffic control system.

18. The apparatus of claim 16, the one or more processors are further configured to establish one or more additional communication channels with one or more other relay aircraft.

19. The apparatus of claim 16, wherein the at least one detection operation comprises detecting transponder data associated with one or more transponders or detecting aircraft audio data.

20. A computer program product comprising at least one non-transitory computer-readable storage medium having computer program code stored thereon that, in execution with at least one processor, configures the computer program product for:
determining that a first communication channel between a first aircraft and an aviation operations control system is unavailable;
detecting one or more other aircraft using at least one detection operation, wherein the one or more other aircraft are in proximity to the first aircraft;
identifying aircraft operations data associated with the one or more other aircraft;
determining a relay aircraft from the one or more other aircraft by applying the aircraft operations data to a relay aircraft model, wherein the aircraft operations data is indicative of one or more aviation-related features associated with the one or more other aircraft;
causing a second communication channel to be established between the first aircraft and the relay aircraft; and
initiating performance of one or more aviation operation actions using the second communication channel.
